(19) United States
(12) Patent Application Publication
(10) Pub. No.: US 2009/0011357 A1
(43) Pub. Date: Jan. 8, 2009

(54) TONER, METHOD OF MANUFACTURING THE SAME, TWO-COMPONENT DEVELOPER USING THE SAME, DEVELOPING DEVICE, AND IMAGE FORMING APPARATUS

(76) Inventors: Yoshitaka Kawase, Nara-shi (JP); Masao Suzuki, Shimotsuga-gun (JP)

Correspondence Address: NIXON & VANDERHYE, PC, 901 NORTH GLEBE ROAD, 11TH FLOOR, ARLINGTON, VA, 22203, US

(21) Appl. No.: 12/168,340

(22) Filed: Jul. 7, 2008

(30) Foreign Application Priority Data
Jul. 6, 2007 (JP) P2007-178961

(51) Int. Cl. G03G 9/08; G03G 5/00

(52) U.S. Cl. 430/110.1; 430/137.1

(57) ABSTRACT

A toner is a capsule particle including a toner particle composed of a core particle that is a resin particle and shell particles covering the surface of the core particle. The toner is manufactured by controlling the particle size so that the toner particles have a volume average particle size of 4.0 or more and 8.0 μm or less, and a ratio of a toner particle having a number average particle size of 3.0 μm or less of 8% by number or more and 25% by number or less to the entirety of the toner particles. The shell particles are melt-bonded to the core particle to be integrated therewith.

### CROSS-REFERENCE TO RELATED APPLICATION

This application claims priority to Japanese Patent Application No, 2007-178961/which was filed on Jul. 6, 2007, the contents of which are incorporated herein by reference in its entirety.

### BACKGROUND OF THE INVENTION

1. Field of the Invention

The present invention relates to a toner, a method of manufacturing the same, a two-component developer using the same, a developing device, and an image forming apparatus.

2. Description of the Related Art

As a process of manufacturing a toner, the kneading pulverization method has been widely used hitherto. However, a pulverized toner particle has an indeterminate form. A pulverized surface formed during pulverization becomes a toner particle surface; thus, the composition of the surface easily becomes uneven, and the composition is not easily controlled into an even state. When the toner particle form is an indeterminate form, the fluidity of the toner deteriorates or the toner composition becomes uneven so that problems such as generation of fog or toner scattering are caused.

There has been also suggested a wet method of manufacturing a toner instead of the pulverization method. However, in the wet method, a large amount of a dispersion stabilizer is used; accordingly, the component partially remains on the toner particle surface so that the humidity resistance decreases or the charging characteristics deteriorate. In particular, the method has a drawback that the charging characteristics easily become remarkably unstable. Among performances required for toner, the charging characteristics are particularly important, which produces a large effect on the behavior or quality in development or transferring (such as control of a color adjusting process or a transfer process).

On the other hand, with a trend of an increase in image quality in recent years, there is a tendency that a decrease in the particle size of toner particles has been advanced and the content of toner particles having a small particle size, which are each a fine particle, has increased. About two-component developers containing the toner particles having a small particle size, the toner particles having a small particle size is cracked or the shape thereof is changed by stress inside a developing device, so that the toner is spent to a carrier and the charging characteristics of the developer deteriorate accordingly. This is one of factors of causing a deterioration in image quality.

Thus, required is the design of toner which is good in fluidity, transferability and others, has charging performance and excellent offset resistance and tracking resistance, and has various other functions. Capsule toner is suggested, wherein the surface of the toner particle is covered with a resin layer.

In a technique disclosed in Japanese Unexamined Patent Publication JP-A 3-5763 (1991), the phase separating method is adopted as an encapsulating method for capsule toner. In the phase separating method, a shell material is dissolved and core particles are dispersed in a good solvent wherein the core particles are slightly soluble or insoluble and further the shell material is satisfactorily soluble. Next, thereto is added a poor solvent which is well compatible with the good solvent but has a low capability of dissolving the shell material. In this way, the shell material is precipitated on each surface of the core particles. When core particles containing at least a colorant and a soft solid substance are each covered with an outer shell in toner particles having a small particle size and further the particle size distribution thereof is specified, capsule toner can be obtained which is excellent fine line reproducibility and tone reproducibility and is hardly changed in performance even in the case where the toner is used for a long term.

In a technique disclosed in International Publication WO00/13063, the additive suspension polymerization method is adopted as an encapsulating method for capsule toner. The additive suspension method is a method of suspending and polymerizing a polymerizable monomer for shells in the presence of colored polymer core particles, obtained by suspension polymerization, in an aqueous dispersing medium at ambient temperature to carrying out encapsuling. By specifying the particle size distribution of polymeric toner particles containing at least a binder resin and a colorant and having a core/shell structure and a small particle size, a decrease in the quality of images obtained from the toner can be prevented even in the case where the toner is used over a long term.

In the technique disclosed in JP-A 3-5763, it is essential that considering the solubility parameters of the core particles, the shell material and the solvents, the materials are selected. Thus, the latitude in which the materials should be selected is narrow. Moreover, the toner deteriorates easily since the covering strength of the shell material is weak. As a result, the initial characteristics of the toner cannot be kept.

In the technique disclosed in WO00/13063, the latitude in which the polymerizable monomer for shells, and the other materials should be selected is narrow, and further the core particles and the shell material cannot be caused to adhere strongly to each other. Thus, the initial characteristics cannot be kept.

### SUMMARY OF THE INVENTION

An object of the invention is to solve the problems in the prior art, and provide a toner which is prevented from being spent to a carrier, restrains a deterioration in the charging characteristics of a developer due to the toner spent, has a wide latitude in which raw materials should be selected, and has excellent long-term stability, durability, charging stability, and filming resistance, so as to have capability of forming good images; a method of manufacturing the toner; a two-component developer using the toner; a developing device; and an image forming apparatus.

The invention provides a toner comprising toner particles each composed of a core particle including a binder resin and a colorant and shell particles covering the core particle,

the toner particles having a volume average particle size of 4.0 μm or more and 8.0 μm or less,

the toner particles including toner particles having a number average particle size of 3.0 μm or less, at a ratio of 8% by number or more and less than 25% by number to an entirety of the toner particles, and

a part of each of the shell particles being melt-bonded to at least one of the core particle and another shell particle adjacent thereto whereby a projection is formed.

According to the invention, toner comprising toner particles each composed of a core particle including a binder resin and a colorant and shell particles covering the core particle. The toner particles have a volume average particle size of 4.0 μm or more and 8.0 μm or less, and includes toner particles having a number average particle size of 3.0 μm or less, at a ratio of 8% by number or more and less than 25% by number to the entirety of the toner particles. A part of each of the shell particles is melt-bonded to at least one of the core particle and another shell particle whereby a projection is formed.

When the volume average particle size of the toner particles is less than 4.0 μm, a sufficient image resolution is obtained. However, in a case where the image ratio by area of an image formed from the toner is high or in some other case, the amount of the toner transferred on a to-be-transferred medium becomes small, so that the density of the image decreases. Additionally, conditions for production of the toner are sever, so that the yield decreases largely. Thus, costs for the production increase. When the volume average particle size of the toner particles is more than 8.0 μm, the image resolution decreases.

When a ratio of toner particles having the number average particle size of 3.0 μm or less to the entirety of the toner particles is less than 8% by number to total amount of the toner particles, the amount of toner particles having a fine particle size is small; thus, in particular, when the formation of images is continued and the toner is continuously used, the amount of toner particles having a fine particle size decreases and the resolution of the formed images and the density thereof decrease. When the ratio is more than 25% by number, the toner is melt-bonded to a developing blade and a filming of the toner onto a developing roller, a photoreceptor and the like is generated. Moreover, the toner particles having the number average particle size of 3.0 μm or less are not easily charged into a sufficient extent by means of a developing blade or developing roller; therefore, when the content of the toner particles having the number average particle size of 3.0 μm or less in the toner is more than 25% by number, the charging stability deteriorates so that toner-scattering is easily caused. Fogging of images made from the toner is easily caused by the scattered toner.

The toner of the invention is a capsule toner comprising toner particles in each of which a surface layer region of the core particle is covered with the shell particles, and a part of each of the shell particles is melt-bonded to at least one of the core particle and another shell particle adjacent thereto, whereby a cover layer is formed. When the shell particles are melt-bonded to each other to be integrated with each other, the strength of the cover layer increases. When the shell particles and the core particle are melt-bonded to each other to be integrated with each other, the strength of the adhesion between the cover layer and the core particle increases. As a result, the detachment of the cover layer from the core particle, which may be caused by, for example, the stirring of the toner in a developing container, can be prevented, so that the peeling of the cover layer is not easily caused. Accordingly, the toner particle surface is made even, and properties of the toner, such as the fluidity, anti-blocking property and charging stability thereof, can be prevented from being varied by the use of the toner over a long term. Moreover, the generation of the toner spent to a carrier can be prevented.

Additionally, the surface of the core particle is covered with the shell particles, so that fine projections are formed in the surface of the cover layer. In this way, the toner is easily caught on a cleaning blade so as to improve the cleanability of the toner. About the materials of the core particle and the shell particles, the materials may be selected independently of the solubility parameters thereof in a solvent. Thus, the materials can each be selected in a wide latitude.

Further, in the invention, it is preferable that the volume average particle size of the toner particles is 4.0 μm or more and 6.0 μm or less, and toner particles having the number average particle size of 3.0 μl or less are contained at a ratio of 10% by number or more and less than 20% by number to the entirety of the toner particles.

According to the invention, the volume average particle size of the toner particles is 4.0 μm or more and 6.0 μm or less, and toner particles having the number average particle size of 3.0 μm or less are contained at a ratio of 10% by number or more and less than 20% by number to the entirety of the toner particles.

When the volume average particle size of the toner particle is 6.0 μm or less, the image resolution is further improved. When the ratio of toner particles having the number average particle size of 3.0 μm or less is 10% by number or more and less than 20% by number to the entirety of the toner particles, which means that toner particles having a fine particle size, which are effective for forming high-quality images, are contained in a large amount. Thus, in particular, even in the case where the formation of images is continued and the toner is continuously used, the toner particles having a fine particle size remain in a large amount; thus, a decrease in the resolution of formed images and the density thereof can be more effectively prevented.

Further, in the invention, it is preferable that 90% or more of the surface area of the core particle is covered with the shell particles.

According to the invention, 90% or more of the surface area of the core particle is covered with the shell particles, when the core particle is sufficiently covered with the shell particles, low-melting-point components contained in the core particle softens, to prevent the toner particles from aggregating. When less than 90% of the surface area of the core particle is covered with the shell particles, the area of uncovered regions of the core particle increases and the low-melting-point components contained in the core particle softens so that the toner particles may unfavorably aggregate.

Further, in the invention, it is preferable that a ratio of a projection average particle size, which is an average of projection particle sizes, which are each an average of long and short sizes of the respective projections, to a core average particle size, which is an average of core particle sizes, which are each an average of long and short sizes of the respective existing core particles, is 0.01 or more and 0.2 or less.

According to the invention, the ratio of a projection average particle size, which is an average of projection particle sizes, which are each an average of long and short sizes of the respective projections, to a core average particle size, which is an average of core particle sizes, which are each an average of long and short sizes of the respective existing core particles, is 0.01 or more and 0.2 or less.

A projection average particle size A is as follows: the projections made of the shell particles that are contained in the existing cover layers and are in a melt-bonded state are viewed from the surface of the cover layer; and the average of the projection particle sizes, which are each the average of long and short sizes of the respective projections measured at this time of the viewing, is the projection average particle size A. A core average particle size B is as follows: the core particles are each viewed from a single direction thereof, and the average of the core particle sizes, which are each the average of long and short sizes of the respective core particles measured at the time of the viewing, is the core average particle size B. When the ratio therebetween (A/B) is set to 0.01 or more and 0.2 or less, the thickness of the cover layers can be made appropriate and the breakdown of the cover layers based on the stirring of the toner in a developing container can be prevented. Additionally, the cover layers containing the shell particles can each be formed over the entirety of the surface of the core particle. Furthermore, the height of the projections can be made appropriate. As a result, the denaturation of the toner can stably be prevented over a longer term, and further the cleanability of the toner can be improved.

When the ratio of the projection average particle size A to the core average particle size B is less than 0.01, the thickness of the cover layers is smaller than the core average particle size B so that the cover layers may be broken down by the stirring of the toner in a developing toner. Thus, the stability of the toner over time may not be obtained, when the ratio is more than 0.2, the average particle size of the shell particles before the formation of the cover layers is larger than the core average particle size B so that the melt-bonding between the shell particles and the respective core particles and between the shell particles become difficult. Thus, it is feared that the cover layers containing the shell particles cannot each be formed over the whole of the surface of the core particle.

Further, in the invention, it is preferable that the shell particles contain at least one of a styrene-acrylic copolymer resin and a polyester resin.

According to the invention, the shell particles contain at least one of a styrene-acrylic copolymer resin and a polyester resin. The resins are light and inexpensive, have a high strength and a high transparency, and have many other advantages. Besides, the thickness of the cover layers can easily be made appropriate and the denaturation of the toner can stably be prevented over a longer term.

Further, the invention provides a method of manufacturing the toner, comprising a step of contacting the core particles with the shell particles in the presence of an adhesion aiding agent for increasing an adhesive strength between the respective core particles and the shell particles.

According to the invention, the core particles are brought into contact with the shell particles in the presence of an adhesion aiding agent for increasing the adhesive strength between the respective core particles and the shell particles, thereby manufacturing the toner, which have the advantageous effects. The adhesion aiding agent causes an improvement in the wettability of the shell particles to the respective core particles to increase the adhesive strength between the respective core particles and the shell particles. The use of the adhesion aiding agent makes it easy to form the cover layers containing the shell particles on the entire surfaces of the core particles or on most of the entire surfaces. The cover layers do not easily detach from the core particles by the presence of the shell particles melt-bonded to the core particles. It is therefore possible to prevent a matter that the cover layers are detached by the use of the toner for a long term so that the properties of the toner are varied. Moreover, non-melt-bonded moieties of the shell particles covering the core particles form fine projections on the surfaces of the cover layers; thus, the toner is easily caught on a cleaning blade so that the cleanability of the toner can be improved.

Further, in the invention, it is preferable that the volume average particle size of the shell particles is 0.05 μm or more and 1 μm or less.

According to the invention, the volume average particle size of the shell particles is 0.05 μm or more and 1 μm or less. This makes it possible to make the average particle size of the projections, which are formed by melt-bonding between the shell particles and the respective core particles or between the shell particles adjacent to each other, that is, the thickness of the cover layers appropriate.

When the volume average particle size of the shell particles is less than 0.05 μm, the shell particles are not easily fixed to each surface of the core particles so that the thickness of the formed cover layers becomes small. Accordingly, the thickness is not easily controlled and the cover layers do not easily cover each surface of the core particles evenly. Thus, as the cover layers, cover layers having an even thickness cannot be obtained. It is therefore feared that the characteristics of the toner, such as the fluidity, the anti-blocking property and the charging stability thereof, deteriorate. Additionally, the size of the particles becomes too small so that the handleability of the shell particles deteriorates. Besides, in the case of selecting a method of spraying a shell particle dispersed liquid which contains the shell particles and the adhesion aiding agent from a single spray nozzle in a coating step, the dispersibility of the shell particles in the shell particle dispersed liquid may deteriorate. When the volume average particle size is more than 1 μm, the height of the formed projections increases so that the occupation ratio of the cover layers in the toner particles increases, when the occupation ratio of the cover layers in the toner particles increases, the cover layers may produce an excessively large effect on images when the images are formed; however, this effect depends on the material of the cover layers. Thus, the images may not become desired images. Additionally, the cover layers become too thick or the shell particles detach from the surfaces of the core particles so that the cover layers cannot be made into an even thickness.

Further, in the invention, it is preferable that the adhesion aiding agent contains at least one of water and a lower alcohol.

According to the invention, the adhesion aiding agent contains at least one of water and a lower alcohol. The use of the adhesion aiding agent as a material containing any one of these compounds makes it possible to enhance the wettability of the shell particles to the respective core particles. As a result, it becomes easier to form the cover layers containing the shell particles on the entire surfaces of the core particles or on most of the entire surfaces. Moreover, the drying time for removing the adhesion aiding agent can be made shorter.

Further, the invention provides a two-component developer containing the toner and a carrier.

According to the according to, it is preferred that a two-component developer contains the toner, which produces the advantageous effects, and a carrier. According to this two-component developer, an image having a sufficient image density and a high resolution can be formed without generating melt-bonding of the toner to a developing blade, filming onto a developing roller, a photoreceptor and the like, nor fog based on toner-scattering.

Further, the invention provides a developing device performing a development by using a developer containing the toner.

According to the invention, it is preferred that a developing device performs a development by using the developer containing the toner which produces the advantageous effects. According to this developing device, a toner image having a high resolution can stably be formed on a photoreceptor.

Further, the invention provides an image forming apparatus having the developing device.

According to the invention, it is preferred that an image forming apparatus has the developing device which produces the advantageous effects. According to this image forming apparatus, an image having a sufficient image density and a high resolution can be formed.

### BRIEF DESCRIPTION OF THE DRAWINGS

Other and further objects, features, and advantages of the invention will be more explicit from the following detailed description taken with reference to the drawings wherein:

FIG. 1 is a sectional view which schematically illustrates an example of a toner particle constituting toner of the invention;

FIG. 2 is a process flow chart showing steps in a method of manufacturing toner according to an embodiment of the invention;

FIG. 3 is a view which schematically illustrates the structure of an image forming apparatus of the invention;

FIG. 4 is a schematic view illustrating the structure of the developing device.

### DETAILED DESCRIPTION

Now referring to the drawings, preferred embodiments of the invention are described below.

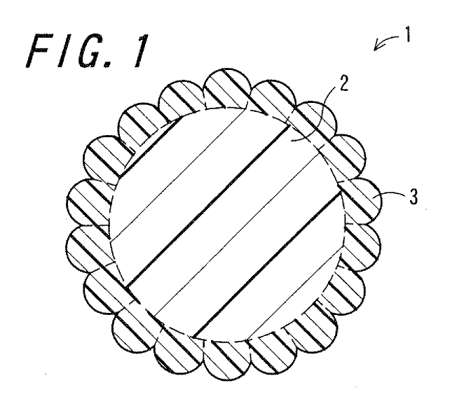

FIG. 1 is a sectional view which schematically illustrates an example of a toner particle 1 constituting toner of the invention. The toner particle is a capsule toner including the toner particle 1 composed of a core particle 2 and shell particles 3, the core particle being a resin particle and the shell particles being resin particles covering the surface of the core particle 2. Preferably, the toner is manufactured by controlling the particle sizes of the used core particles and the particle sizes of the core particles after the core particles are covered with the shell particles so that the volume average particle size of the toner particles is set to 4.0 μm or more and 8.0 μm or less and toner particles having the number average particle size of 3.0 μm or less are contained at a ratio of 8% by number or more and less than 25% by number to the entirety of the toner particles.

When the volume average particle size of the toner particles is less than 4.0 μm, a sufficient image resolution is obtained; however, in a case where the image ratio by area of an image formed from the toner is high or in some other case, the amount of the toner transferred on a to-be-transferred medium becomes small so that the density of the image decreases. Additionally, conditions for the production of the toner are severe so that the yield decreases largely. Thus, costs for the production increase. When the volume average particle size of the toner particles is more than 8.0 μm, the image resolution decreases.

When the ratio of the toner particles having the number average particle size of 3.0 μm or less to the entirety of the toner particles is less than 8% by number, the amount of toner particles having a fine particle size is small; thus, in particular, when the formation of images is continued so that the toner is continuously used, the amount of the toner particles having a fine particle size decreases so that the resolution of the formed images and the density thereof decrease. When the ratio is more than 25% by number, the toner is melt-bonded to a developing blade and a filming of the toner onto a developing roller, a photoreceptor and the like is generated. Moreover, the toner particles having the number average particle size of 3.0 μm or less are not easily charged into a sufficient extent by means of a developing blade or developing roller; therefore, when the content by percentage of the toner particles having the number average particle size of 3.0 μm or less in the toner is more than 25% by number, the electrification stability deteriorates so that toner-scattering is easily caused. Fogging of images made from the toner is easily caused by the scattered toner.

The toner of the invention is a capsule toner including a toner particle 1 in which a surface layer region of the core particle 2 is covered with the shell particles 3. The respective shell particles 3 is melt-bonded to at least one of the core particle 2 and another shell particle adjacent thereto, and form a cover layer. When the shell particles 3 are melt-bonded to each other so as to be integrated with each other, the strength between the cover layers increases, when the shell particles 3 and the core particle 2 are melt-bonded to each other to be integrated with each other, the strength of the adhesive between the cover layer and the core particle 2 increases, in this way, the detachment of the cover layer from the core particle, which may be caused by, for example, the stirring of the toner in a developing container, can be prevented, so that the peeling of the cover layer is not easily caused. Accordingly, the toner particle surface is made even, and properties of the toner, such as the fluidity, the anti-blocking property and the charging stability thereof, can be prevented from being varied by the use of the toner over a long term. Moreover, the generation of the toner spent to the carrier can be prevented.

Additionally, the surface of the core particle 2 is covered with the shell particles 3, so that fine projections are formed in the surface of the cover layer. In this way, the toner is easily caught on a cleaning blade so as to improve the cleanability of the toner. About the materials of the core particle 2 and the shell particles 3, the materials may be selected independently of the solubility-parameters thereof in a solvent. Thus, the materials can each be selected in a wide latitude.

In the toner of the invention, the toner particles have the volume average particle size of 4.0 μm or more and 6.0 μm or less, and a ratio of toner particles having the number average particle size of 3.0 μm or less of 10% by number or more and less than 20% by number to the entirety of the toner particles.

When a toner particle has the volume average particle size of 6.0 μm or less, the image resolution is further improved. When the ratio of the toner particles having the number average particle size of 3.0 μm or less to the entirety of the toner particles is 10% or more by number and less than 20% by number, toner particles having a fine particle size, which are effective for forming high-quality images, are contained in a large amount. Thus, in particular, even in the case where the formation of images is continued so that the toner is continuously used, the toner particles having a fine particle size remain in a large amount; thus, a decrease in the resolution of formed images and the density thereof can be more effectively prevented.

In the toner particle 1 constituting the toner of the invention, the ratio of the projection average particle size, which is the average of the projection particle sizes, which are each the average of long and short sizes of the respective projections, to the core average particle size, which is the average of the core particle sizes, which are each the average of long and short sizes of the core particle 2, is 0.01 or more and 0.2 or less.

The projection average particle size A is calculated out as follows: For example, a photograph of toner particles wherein cover layers are formed is taken at a magnification power of 10,000 with an electron microscope (trade name: VE-9800, manufactured by KEYENCE CORPORATION). Next, in the taken photograph of the toner particles, circles having a radius of 1.5 μm (1.5 cm in the photograph), the number of which is, for example, 5, are set in the photographed image of the toner particles. About projections which are formed from shell particles that are present in the set circles and are in a melt-bonded state constitute, the projection average particle size A is obtained. The shell particles which are partially in a melt-bonded state form projections in the surfaces of the cover layers. About any one of the projections in any one of the set circles, the lengths of straight lines connected to concaves which form the projection and passed at the center of the shell particle are measured. The lengths of the straight lines will be referred to as the “distances between the concaves” hereinafter. The center of the shell particle is the most convex portion of the projection, and is specified with, for example, the naked eye. Among the distances between the concaves, which constitute the projection, the minimum distance is defined as a short size A1. The maximum distance is defined as a long size A2. The average of the short size A1 and the long size A2, that is, the average size {(A1+A2)/2} is calculated. Furthermore, such averages are calculated about a plurality of other projections in the circles. The average of the calculated values is then obtained. The thus-calculated value is defined as the projection average particle size A, that is, the average particle size of the shell particles that are contained in the cover layers and are in a melt-bonded state.

The core average particle Size B is calculated out as follows; A photograph of the core particles of the toner particles is taken at a magnification power of 5,000 with, for example, the electron microscope. From this taken photograph, a short size B1 and a long size B2 of one of the core particles are measured. The average of the short size B1 and the long size B2, that is, the average particle size {(B1+B2)/2} is then calculated. Furthermore, such average particle sizes are calculated about a plurality of other core particles present in the circles. The average of these values is calculated. The thus-calculated value is defined as the core average particle size B.

When the ratio of A/B, which is the ratio of the projection average particle size A to the core average particle size B calculated by the method, is 0.01 or more and 0.2 or less, the thickness of the cover layers can be made appropriate and the breakdown of the cover layers based on the stirring of the toner in a developing container can be prevented. Additionally, the cover layers containing the shell particles can each be formed over the whole of the surfaces of the core particles. Furthermore, the height of the projections can be made appropriate. As a result, the denaturation of the toner can stably be prevented over a longer term, and further the cleanability of the toner can be improved.

When the ratio of the projection average particle size A to the core average particle size B is less than 0.01, the thickness of the cover layers is smaller than the core average particle size B so that the cover layers may be broken down by the stirring of the toner in a developing toner. Thus, the stability of the toner over time may not be obtained. When the ratio is more than 0.2, the average particle size of the shell particles before the formation of the cover layers is larger than the core average particle size B so that the melt-bonding between the shell particles and the respective core particles and that between the shell particles become difficult. Thus, it is fear that the cover layers containing the shell particles cannot each be formed over the whole of the surfaces of the core particles.

About the core particles 2 contained in the toner of the invention, the core average particle size B is preferably 3.8 μm or more and 5.8 μm or less, more preferably 4.0 μm or more and 5.5 μm or less. When the core average particle size B is in the range, highly-minute images can stably be formed over a long term. When the core average particle size B is less than 3.8 μm, the particle size of the core particles becomes too small so that an increase in the charging characteristics and a decrease in the fluidity may be caused. When the increase in the charging characteristics and the decrease in the fluidity are caused, the toner cannot be supplied stably onto a photoreceptor. Thus, background fog, a decrease in image density and other drawbacks may be caused. When the core average particle size B is more than 5.8 μm, highly-minute images are not easily obtained because the particle size of the core particles is large. By the increase in the particle size of the core particles, the specific surface area is reduced so that the charge amount of the toner decreases. When the charge amount of the toner decreases, the toner is not stably supplied onto a photoreceptor so that the machine may be contaminated by toner-scattering.

The shell particles 3 contained in the toner particle 1 constituting the toner of the invention preferably contain at least one of a styrene-acrylic copolymer resin and a polyester resin. The resins are light and inexpensive, have a high strength and a high transparency, and have many other advantages. Besides, the thickness of the cover layers can easily be made appropriate and the denaturation of the toner can stably be prevented over a longer term.

The volume average particle size of the shell particles 3 in the toner of the invention is preferably 0.05 μm or more and 1 μm or less. This makes it possible to make the average particle size of the projections, which are formed by melt-bonding between the shell particles and the respective core particles or between the shell particles adjacent to each other, that is, the thickness of the cover layers appropriate.

When the volume average particle size of the shell particles is less than 0.05 μm, the shell particles are not easily fixed to the surfaces of the core particles so that the thickness of the formed cover layers becomes small. Accordingly, the thickness is not easily controlled and the cover layers do not easily cover the surfaces of the core particles evenly. Thus, as the cover layers, cover layers having an even thickness cannot be obtained. It is therefore feared that characteristics of the toner, such as the fluidity, the anti-blocking property and the charging stability thereof, deteriorate. Additionally, the size of the particles becomes too small so that the handleability of the shell particles deteriorates. Besides, in the case of selecting a method of spraying a shell particle dispersed liquid which contains the shell particles and the adhesion aiding agent from a single spray nozzle in a coating step, the dispersibility of the shell particles in the shell particle dispersed liquid may deteriorate. When the volume average particle size is more than 1 μm, the height of the formed projections increases so that the occupation ratio of the cover layers in the toner particles increases. When the occupation ratio of the cover layers in the toner particles increases, the cover layers may produce an excessively large effect on images when the images are formed; however, this effect depends on the material of the cover layers. Thus, the images may not become desired images. Additionally, the cover layers become too thick or the shell particles detach from the surfaces of the core particles so that the cover layers cannot be made into an even thickness.

The respective cover layers made of the shell particles are formed on the surface of the respective core particles. When the cover layer is partially formed on a surface of the core particle, it is preferred that the cover layer is formed on most of the surface of the core particle. Most of the surface of the core particle means a core particle surface area or region having an occupation ratio of 50% or more of the surface of the core particle, when the core particle area where the cover layer is formed is less than 50% of the surface of the core particle, the area of a naked region of the core particle increases. Thus, low-melting-point components contained in the core particle softens so that the toner particles may aggregate. Accordingly, the core particle area where the cover layer is formed is preferably 50% or more and 100% or less of the surface of the core particle, more preferably 90% or more and 100% or less thereof. The surface area of the core particle can be calculated by regarding the core particle as a sphere and then measuring the volume average particle size of the core particle. The core particle area where the cover layer is formed can be calculated from an image thereof photographed with an electron microscope, using an image analyzer or the like. When the cover layer is formed on most of the surface of the core particle, produced are the same advantageous effects as when the cover layer is formed on the whole of the surface of the core particle; thus, a case where the cover layer is formed on the whole of the surface of the core particle will be described as an example hereinafter.

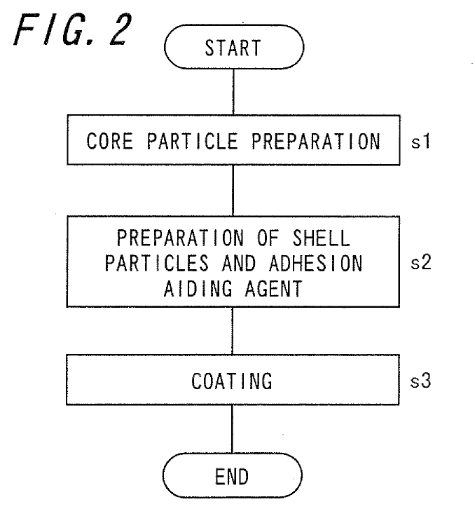

FIG. 2 is a process flow chart showing steps in a method of manufacturing toner according to an embodiment of the invention. The method of manufacturing the toner of the embodiment includes a core particle preparation step of Step s1, a shell-particle-and-adhesion-aiding-agent preparation step of Step s2, and a coating step of Step s3. The core particle preparation step of Step s1 and the shell-particle-and-adhesion-aiding-agent, preparation step of Step s2 may be reverse in the process order.

The toner particle constituting the toner of the invention contains a binder resin, a colorant and other toner additive components. Examples of the other toner additive components include a release agent, a charge control agent and the like. A method of manufacturing the toner of the invention will be described hereinafter. The toner of the invention is manufactured, for example, by using an adhesion aiding agent, for increasing the additive force between core particles and shell particles, to cause the shell particles to adhere onto the core particles, thereby melt-bonding the particles.

<Core Particle Preparation Step>

In the core particle preparation step of Step s1, core particles are prepared which contain at least a binder resin and a colorant. The core particles used for the toner of the invention contain at least a binder resin and a colorant, and may further contain a release agent, a charge control agent, and the like.

The binder resin is not particularly limited as long as the rein is a resin that is ordinarily used as a binder resin for toner. Examples thereof include polyester, polyurethane, epoxy resins, acrylic resins, styrene-acrylic resins, and the like. Among these resins, preferred are polyester, acrylic resins and styrene-acrylic resins. These resins may be used each alone, or two or more of them may be used in combination. It is allowable to use two or more resins that are the same in kind but are different from each other in one or more Selected from molecular weight, monomer composition, and others.

Polyester is suitable as a binder resin for color toner since the polymer is excellent in transparency and can give good powder fluidity, low-temperature fixability, secondary color reproducibility and other characteristics to aggregated particles. As polyester, known species may be used. Example thereof include a polycondensation product produced from a polybasic acid and a polyhydric alcohol, and the like. The polybasic acid may be one known as a monomer for polyester. Examples thereof include aromatic carboxylic acids, such as terephthalic acid, isophthalic acid, phthalic anhydride, trimellitic anhydride, pyromellitic acid, and naphthalenedicarboxylic acid; aliphatic carboxylic acids such as maleic anhydride, fumaric acid, succinic acid, alkenylsuccinic anhydride, and adipic acid; methyl esters of these polybasic acids; and the like. The polybasic acids may be used each alone, or two or more of them may be used in combination. The polyhydric alcohol may be one known as a monomer for polyester. Examples thereof include aliphatic polyhydric alcohols such as ethylene glycol, propylene glycol, butanediol, hexanediol, neopentyl glycol, and glycerin; alicyclic polyhydric alcohols such as cyclohexanediol, cyclohexanedimethanol, and hydrogenated bisphenol A; aromatic diols such as an ethylene oxide adduct of bisphenol A, and a propylene oxide adduct of bisphenol A; and the like. The polyhydric alcohols may be used each alone, or two or more of may be used in combination.

Polycondensation reaction between the polybasic acid and the polyhydric alcohol may be carried out in accordance with a usual method. For example, the polybasic acid and the polyhydric alcohol are brought into contact with each other in the presence of a polycondensing catalyst and the presence or the absence of an organic solvent. The reaction is terminated at the time when the acid value, the softening temperature and other characteristics of the resultant polyester turn to predetermined values. In such a way, polyester is obtained. When a methyl ester of the polybasic acid is used instead of a part of polybasic acids, de-methanolysis polycondensation reaction is carried out. In the case of varying, in this polycondensation reaction, the blend ratio between the polybasic acid and the polyhydric alcohol, the reaction ratio therebetween and others appropriately, for example, the content of carboxyl groups in terminals of molecules of the polyester can be adjusted. As a result, characteristics of the resultant polyester can be altered. When trimellitic anhydride is used as the polybasic acid, a modified polyester is obtained also by introducing carboxyl groups into the main chain of polyester easily. It is allowable to bond a hydrophilic group such as a carboxyl group or a sulfonic group to the main chain and/or side chains of polyester to produce a self-dispersible polyester in water, and use the polyester in water. It is also allowable to graft a polyester and an acrylic resin to each other, and use the resultant.

An acrylic resin is not particularly limited, and is preferably an acid-group-containing acrylic resin. The acid-group-containing acrylic resin may be produced, for example, by polymerizing acrylic resin monomers, or an acrylic resin monomer and a vinyl monomer by using the acrylic resin monomer which contains an acid group or a hydrophilic group and/or the vinyl monomer which has an acid group or a hydrophilic group together. The acrylic resin monomer may be known one. Examples thereof include acrylic acid which may have a substituent, methacrylic acid which may have a substituent, an acrylate which may have a substituent, a methacrylate which may have a substituent, and the like. Specific examples of the acrylic resin monomer include acrylate monomers such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, n-octyl acrylate, decyl acrylate, and dodecyl acrylate; metacrylate monomers such as methyl methacrylate, propyl methacrylate, n-butyl methacrylate, isobutyl methacrylate, n-amyl methacrylate, n-hexyl methacrylate, 2-ethylhexyl methacrylate, n-octyl methacrylate, decyl methacrylate, and dodecyl methacrylate; hydroxyl-containing (meth)acrylate monomers such as hydroxyethyl acrylate, hydroxypropyl methacrylate; and the like. The acrylic resin monomers may be used each alone, or two or more of them may be used in combination. The vinyl monomer may be known one. Examples thereof include styrene, α-methylstyrene, vinyl bromide, vinyl chloride, vinyl acetate, acrylonitrile, methacrylonitrile, and the like. The vinyl monomers may be used each alone, or two or more of them may be used in combination. The polymerization is carried out by solution polymerization, suspension polymerization, emulsion polymerization or some other polymerization using an ordinary radical initiator.

Examples of styrene-acrylic resins include a styrene-methyl acrylate copolymer, styrene-ethyl acrylate copolymer, styrene-butyl acrylate copolymer, styrene-methyl methacrylate copolymer, styrene-ethyl methacrylate copolymer, styrene-butyl methacrylate copolymer, styrene-acrylonitrile copolymer, and the like.

The binder resin preferably has a glass transition temperature of 30° C. or higher and 80° C. or lower. When the glass transition temperature of the binder resin is lower than 30° C., blocking, which is thermal aggregation of toner particles in an image forming apparatus, is easily generated so that the storage stability of the toner may deteriorate, when the glass transition temperature of the binder resin is higher than 80° C., the fixability of the toner onto a recording medium deteriorates so that fixation failure may be caused.

The colorant may be an organic dye, organic pigment, inorganic dye, or inorganic pigment used ordinarily in the field of electrophotography, or some other colorant.

Examples of black colorants include carbon black, copper oxide, manganese dioxide, aniline black, activated carbon, nonmagnetic ferrite, magnetic ferrite, magnetite, and the like.

Examples of yellow colorants include chrome yellow, zinc yellow, cadmium yellow, yellow iron oxide, mineral fast yellow, nickel titanium yellow, navel yellow, Naphthol Yellow S, Hansa Yellow G, Hansa Yellow 10G, Benzidine Yellow G, Benzidine Yellow GR, quinoline yellow lake, Permanent Yellow NCG, tartrazine lake, C.I. Pigment Yellow 12, C.I. Pigment Yellow 13, C.I. Pigment Yellow 14, C.I. Pigment Yellow 15, C.I. Pigment Yellow 17, C.I. Pigment Yellow 93, C.I. Pigment Yellow 94, C.I. Pigment Yellow 138, and the like.

Examples of orange colorants include red chrome yellow, molybdenum orange, Permanent Orange GTR, pyrrazolone orange, vulcan orange, Indanthrene Brilliant Orange RK, Benzidine Orange G, Indanthrene Brilliant Orange GK, C.I. Pigment orange 31, C.I. Pigment Orange 43, and the like.

Examples of red colorants include red iron oxide, cadmium red, red lead, mercury sulfide, cadmium. Permanent Red 4R, lithol red, pyrazolone red, Watchung Red, calcium salts, Lake Red C, Lake Red D, Brilliant Carmine 6B, eosin lake, Rhodamine Lake B, alizarin lake, Brilliant Carmine 3B, C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178, C.I, Pigment Red 222, and the like.

Examples of violet colorants include manganese violet, Fast Violet B, methyl violet lake, and the like.

Examples of blue colorants include iron blue, cobalt blue, alkali blue lake, Victoria blue lake, phthalocyanine blue, metal-free phthalocyanine blue, phthalocyanine blue partial chlorides, fast sky blue, Indanthrene Blue BC, C.I. Pigment Blue 15, C.I. Pigment Blue 15:2, C.I. Pigment 15:3, C.I. Pigment Blue 16, C.I. Pigment Blue 60, and the like.

Example of green colorants include chromium green, chromium oxide, Pigment Green B, malachite green lake, Final Yellow Green G, C.I. Pigment Green 7, and the like.

Examples of white colorants include compounds such as zinc white, titanium oxide, antimony white, and zinc sulfide.

About the colorant, a single kind thereof may be used alone, or two or more kinds thereof in different colors may be used together. Two or more kinds in the same color may be used together. The usage of the colorant is not particularly limited, and is preferably from 0.1 to 20 parts by weight, more preferably from 0.2 to 10 parts by weight with respect to 100 parts by weight of the binder resin.

The release agent may be one that is ordinarily used in the present field. Examples thereof include petroleum wax such as paraffin wax and derivatives thereof, and microcrystalline wax and derivatives thereof; hydrocarbon based synthetic wax such as Fischer-Tropsch wax and derivatives thereof, polyolefin wax (such as polyethylene wax and polypropylene wax) and derivatives thereof, low molecular weight polypropylene wax and derivatives thereof, and polyolefin polymer wax (such as low molecular weight polyethylene wax) and derivatives thereof; plant wax such as carnauba wax and derivatives thereof, rice wax and derivatives thereof, candelilla wax and derivatives thereof, and Japan wax; animal wax such as beeswax wax, and spermaceti; oil and fat synthetic wax such as fatty acid amides, and phenol fatty acid esters; higher ratty acids such as long-chain carboxylic acids and derivatives thereof, long-chain alcohols and derivatives thereof, and silicone polymers; and the like. Examples of the derivatives include oxides, block copolymers of a vinyl monomer and the wax, graft modified products of a vinyl monomer and the wax, and the like. The usage of the wax is not particularly limited, and may be appropriately selected from in a wide range. The amount is preferably from 0.2 to 20 parts by weight, more preferably from 0.5 to 10 parts by weight, even more preferably from 1.0 to 8.0 parts by weight with respect to 100 parts by weight of the binder resin.

The charge control agent may be an agent for controlling positive charges or an agent for controlling negative charges that is ordinarily used in the field. Examples of the charge control agent for controlling positive charges include basic dyes, tertiary ammonium salts, tertiary phosphonium salts, aminopilin, pyrimidine compounds, polynuclear polyamino compounds, aminosilanes, nigrosin dyes and derivatives thereof, triphenylmethane derivatives, guanidine salts, amidine salts, and the like. Examples of the charge control agent for controlling negative charges include oil-soluble dyes such as oil black and spilon black, metal-containing azo compounds, azo complex dyes, naphthonic acid metal salts, metal complexes and metal salts (metal: chromium, zinc, zirconium, or some other metal) of salicylic acid and derivative thereof, fatty acid soaps, and long-chain alkylcarboxylic acid salts, resin acid soaps, and the like. The charge control agents may be used each alone, or two or more of them may be used in combination. The usage of the charge control agent(s) is not particularly limited, and may be appropriately selected from in a wide range. The charge control agent(s) may be incorporated into the core particles, or may be incorporated, for use thereof, into the cover layers made of the shell particles in the coating step, which will be detailed later. When the charge control agent(s) is/are incorporated into the core particles, the amount of the charge control agent(s) is preferably from 0.5 to 3 parts by weight with respect to 100 parts by weight of the binder resin.

The core particles may be produced in accordance with an ordinary method of manufacturing the toner. Examples of the ordinary method of manufacturing the toner include dry methods such as a pulverization method, and wet methods such as a suspension polymerization method, emulsifying coagulation method, dispersion polymerization method, dissolution suspension method, and melt emulsification method. A method for producing the core particles by the pulverization method will be described below.

In the pulverization method, a toner composition containing the binder resin, the colorant and the other toner additive components is subjected to dry mixing by means of a mixer, and then the mixture is melt-kneaded by means of a kneader. The kneaded product obtained by the melt-kneading is cooled to be solidified. The solidified product is pulverized by means of a pulverizer. Thereafter, the resultant particles are classified if necessary, so as to adjust the particle sizes thereof. In this way, the core particles are obtained.

The mixer may be known one. Examples thereof include Henschel type mixers such as HENSCHELMIXER (trade name) manufactured by Mitsui Mining Co., Ltd., SUPERMIXER (trade name) manufactured by KAWATA MFG. Co., Ltd., and MECHANOMILL (trade name) manufactured by Okada Seiko Co., Ltd.; ANGMILL (trade name) manufactured by Hosokawa Micron Corporation; HYBRIDIZATION SYSTEM (trade name) manufactured by Nara Machinery Co., Ltd.; COSMOSYSTEM (trade name) manufactured by Kawasaki Heavy Industries, Ltd; and the like.

The kneader may be known one, and is, for example, a biaxial extruder, a three-axis roll, a laboplast mill or some other ordinary kneader. Specific examples thereof include monoaxial or biaxial extruders such as TEM-100B (trade name) manufactured by Toshiba Machine Co., Ltd., and PCM-65/87 (trade name) manufactured by Ikegai, Ltd., PCM-30 manufactured by Ikegai, Ltd.; and open-roll type kneaders such as KNEADEX (trade name) manufactured by Mitsui Mining Co., Ltd.

Additives for synthetic resins, such as a colorant, may be turned, for use thereof, into the form of a masterbatch in order to disperse the additives evenly into the kneaded product. Two or more of the additives for synthetic resins may be turned, for use thereof, into composite particles. The composite particles can be produced, for example, by adding an appropriate amount of water, a lower alcohol, or the like to two or more of the additives for synthetic resins, using an ordinary granulating machine such as a high-speed mill to granulate the resultant, and then drying the resultant grains. The masterbatch and the composite particles are incorporated into the powdery mixture when the toner composition is dry-mixed.

About the resultant core particles, the core average particle size B is preferably 3.8 μm or more and 5.8 μm or less, more preferably 4.0 μm or more and 5.5 μm or less. When the core average particle size B is in the range, highly-minute images can stably be formed over a long term. When the core average particle size B is less than 3.8 μm, the particle size of the core particles becomes too small so that an increase in the charging characteristics and a decrease in the fluidity may be caused. When the increase in the charging characteristics and the decrease in the fluidity are caused, the toner cannot be supplied stably onto a photoreceptor. Thus, background fog, a decrease in image density and other drawbacks may be caused. When the core average particle size B is more than 5.8 μm, highly-minute images are not easily obtained because the particle size of the core particles is large. By the increase in the particle size of the core particles, the specific surface area is reduced so that the charge amount of the toner decreases. When the charge amount of the toner decreases, the toner is not stably supplied onto a photoreceptor so that the machine may be contaminated by toner-scattering.

(Shell-Particle-and-Adhesion-Aiding-Agent Preparation Step)

In the shell-particle-and-adhesion-aiding-agent preparation step of Step s2, shell particles containing at least a resin are produced, and further an adhesion aiding agent for increasing the adhesive force between the core particles and the shell particles is prepared.

The resin, which can be used in the shell particles, is not particularly limited, and examples thereof include polyester, acrylic resins, styrene-acrylic copolymer resins, styrene resins, and the like. The shell particles preferably contain at least one of a styrene-acrylic copolymer resin and a polyester resin. The resins are light and inexpensive, have a high strength and a high transparency, and have other advantageous effects. The resins easily make it possible to make the thickness of the cover layers appropriate. Thus, the denaturation of the toner can stably be prevented over a longer term.

The resin contained in the shell particles may be the same as or different from the binder resin in the core particles in kind, and is preferably different therefrom in order to reform the toner particle surfaces since a variation in the composition is easily attained. When the resin contained in the shell particles is different from the binder resin in kind, it is preferred that the softening temperature of the resin contained in the shell particles is higher than that of the binder resin in the core particles.

This manner makes it possible to prevent the toner particles from being melt-bonded to each other during storage. Thus, the storage stability can be improved. The softening temperature of the resin contained in the shell particle, which depends on an image forming apparatus wherein the toner is to be used, is preferably 80° C. or higher and 140° C. or lower. The use of the resin whose softening temperature is in the above temperature range makes it possible to obtain a toner having both of storage stability and fixability.

Such shell particles can be obtained, for example, by emulsifying and dispersing raw materials of the shell particles by use of a homogenizer or the like so as to make the materials into fine particles. The shell particles may also be obtained by polymerizing a monomer.

The volume average particle size of the shell particles before the particles are melt-bonded needs to be sufficiently smaller than the core average particle size B, and is preferably 0.05 μm or more and 1 μm or less, more preferably 0.1 μm or more and 0.5 μm or less. Such a manner makes it possible to make the average particle size of the projections, which are formed by melt-bonding between the shell particles and the respective core particles or between the shell particles adjacent to each other, that is, the thickness of the cover layers appropriate.

When the volume average particle size of the shell particles is less than 0.05 μm, the shell particles are not easily fixed to the surfaces of the core particles so that the thickness of the formed cover layers becomes small. Accordingly, the thickness is not easily controlled and the cover layers do not easily cover the surfaces of the core particles evenly. Thus, as the cover layers, cover layers having an even thickness cannot be obtained. It is therefore feared that characteristics of the toner, such as the fluidity, the anti-blocking property and the charging stability thereof, deteriorate. Additionally, the size of the particles becomes too small so that the handleability of the shell particles deteriorates. Besides, in the case of selecting a method of spraying a shell particle dispersed liquid which contains the shell particles and an adhesion aiding agent from a single spray nozzle in the coating step, the dispersibility of the shell particles in the shell particle dispersed liquid may deteriorate. When the volume average particle size is more than 1 μm, the height of the formed projections becomes large so that the occupation ratio of the cover layers in the toner particles increases. When the occupation ratio of the cover layers in the toner particles increases, the cover layers may produce an excessively large effect on images when the images are formed; however, this effect depends on the material of the cover layers. Thus, the images may not become desired images. Additionally, the cover layers become too thick or the shell particles detach from the surfaces of the core particles so that the cover layers cannot be made into an even thickness.

In the shell-particle-and-adhesion-aiding-agent preparation step of Step s2, prepared is an adhesion aiding agent for increasing the adhesive force between the core particles and the shell particles. The adhesion aiding agent is a liquid capable of improving the wettability of the shell particles to the core particles. The adhesion aiding agent is preferably a liquid wherein the core particles are not dissolved. Moreover, the adhesion aiding agent is preferably a liquid that vaporizes easily since the adhesion aiding agent needs to be removed after the coating of the core particles with the shell particles.

As the adhesion aiding agent satisfying these requirements, for example, at least one of water and lower alcohols is preferably contained. Examples of the lower alcohols include methanol, ethanol, propanol, and the like. By the use of materials containing any one of these materials as the adhesion aiding agent, the wettability of the shell particles to the core particles can be enhanced, thereby making it easier to form the cover layers containing the shell particles on the whole of the surfaces of the core particle or most of the surfaces. Moreover, the drying time for removing the adhesion aiding agent can be made shorter.

The adhesion aiding agent is not limited to the examples, and may be selected for use from, for example, the following; alcohols such as butanol, diethylene glycol, and glycerin; ketones such as acetone and methyl ethyl ketone; and esters such as methyl acetate, and ethyl acetate.

(Coating Step)

In the coating step of Step s3, the adhesion aiding agent prepared in Step s2 is used to melt-bond the shell particles onto the respective core particles. In this way, the core particle is coated with the shell particles to form each cover layer.

The adhesion aiding agent causes the wettability of the shell particles to the core particle to be improved, so as to increase the adhesive force between the core particle and the shell particles. The use of the adhesion aiding agent makes it easier to form the cover layer containing the shell particles on the entire surface of the core particle or most of the entire surface. The cover layer does not easily detach from the core particle by the presence of the shell particles melt-bonded to the core particle in the layer, it is therefore possible to prevent a matter that the cover layer is detached by the use of the toner over a long term so that the nature of the toner is changed. Non-melt-bonded regions of the shell particles covering the core particle form fine projections in the surface of the cover layer; thus, the toner is easily caught on a cleaning blade so that the cleanability of the toner can be improved.

The coating step is carried out using, for example, a surface reforming apparatus. The surface reforming apparatus is a device equipped with a container in which the existing core particles and the shell particles are received, and a spraying section for spraying the adhesion aiding agent into the container. In the present embodiment, the surface reforming apparatus has a stirring section for stirring the core particles in the container.

The container, in which the core particles and the shell particles are received, may be a closed-system container. The spraying section is equipped with an adhesion aiding agent storing portion for storing the adhesion aiding agent and/or a carrier gas storing portion for storing a carrier gas, and a liquid spraying unit for mixing the adhesion aiding agent and the carrier gas with each other, spraying the resultant mixture to the core particles received in the container, and spraying liquid droplets of the adhesion aiding agent to the core particles. The carrier gas may be, for example, compressed air. The liquid spraying unit may be a commercially available product. An example thereof is a product wherein a tube pump (trade name: MP-1000A, manufactured by TOKYO RIKAKIKAI CO., LTD.) is connected to a two-fluid nozzle (trade name: HM-6 model, manufactured by Fuso Seiki Co., Ltd.) in such a manner that a quantitative amount of the adhesion aiding agent is sent to the nozzle through the pump. The stirring section may be, for example, a stirring rotor capable of giving mechanical and thermal energies mainly on the basis of impact power to the core particles.

The container having the stirring section may be a commercially available product. Examples thereof include Henschel type mixers such as HENSCHELMIXER (trade name) manufactured by Mitsui Mining Co., Ltd., SUPERMIXER (trade name) manufactured by KAWATA MFG. Co., Ltd., and MECHANOMILL (trade name) manufactured by Okada Seiko Co., Ltd.; ANGMILL (trade name) manufactured by Hosokawa Micron Corporation; HYBRIDIZATION SYSTEM (trade name) manufactured by Nara Machinery Co., Ltd.; and COSMOSYSTEM (trade name) manufactured by Kawasaki Heavy Industries, Ltd. When the liquid spraying unit is fitted into the container of such a mixer, this mixer can be used as the surface reforming apparatus in the embodiment.

The coating of the core particles with the shell particles is carried out as follows: First, the core particles and the shell particles are charged into the container. In the state that the core particles and the shell particles are stirred by the stirring section, the adhesion aiding agent is sprayed into the container. When the adhesion aiding agent is sprayed onto the core particles and the shell particles and further thermal energy is given thereto by the stirring, the surfaces thereof swell and soften so that the wettability is improved. In addition thereto, mechanical impact based on the stirring section is given to the core and shell particles, so that the shell particles are fixed onto the surface of the respective core particles. Furthermore, a part of a shell particle is melt-bonded to at least one of the core particle and another shell particle adjacent thereto of the shell particles. In this way, the shell particles can be caused to adhere onto the whole of the surface of the core particle, and the shell particles can be melt-bonded to the whole of the surface of the core particle.

The temperature of the inside of the container of the surface reforming apparatus is preferably lower than the glass transition temperature of the binder resin contained in the existing core particles. When the temperature of the inside of the container is not lower than the glass transition temperature of the binder resin contained in the core particles, the core particles are excessively melted in the container when the toner is manufactured. Thus, the core particles may aggregate. Accordingly, it is preferred to cool the inside of the container of the surface reforming apparatus appropriately in order to prevent the core particles from aggregating.

It is also preferred to spray the adhesion aiding agent in the state that the core particles float in the container. When the mixture of the shell particles and the adhesion aiding agent is sprayed in this state, it is possible to shorten the time when the core particles on which the adhesion aiding agent is sprayed are brought in contact with each other. This makes it possible to prevent the aggregation of the toner particles when the toner is manufactured. Thus, the generation of coarse particles is prevented. As a result, the manufactured toner is toner having even particle sizes. The state that the core particles float in the container can be realized by, for example, stirring based on the stirring section, or a supply of compressed air sufficient for spraying the adhesion aiding agent.

The use proportion of the shell particles is not particularly limited as long as the use proportion is a use proportion permitting the whole of the surface of the core particle to be covered. The use proportion is preferably 1 part by weight or more and 30 parts by weight or less with respect to 100 parts by weight of the core particles. When the shell particles are used in the proportion range, the shell particles can be caused to adhere onto the whole of the surfaces of the core particles so that the cover layers can be formed on the whole of the surfaces of the core particles. Thus, the following matter can be prevented at a higher probability: a matter that low-melting-point components contained in the core particles exude so that the toner particles aggregate.

When the proportion of the shell particles to 100 parts by weight of the core particles is less than 1 part by weight, the whole of the surfaces of the core particles may not be covered with the cover layers. When the proportion is more than 30 parts by weight, the thickness of the cover layers becomes too large so that the fixability of the toner may deteriorate dependently on the constituent materials of the shell particles.

The usage of the adhesion aiding agent is not particularly limited. The usage is preferably an amount permitting the adhesion aiding agent to get wet on the whole of the surfaces of the core particles. The usage of the adhesion aiding agent is decided in accordance with the usage of the core particles. The amount of the adhesion aiding agent can also be adjusted by the time when the agent is sprayed from the spraying section, the number of times of operations for the spraying, and others. Accordingly, it is advisable to set the spray amount per unit time from the spraying section in accordance with the core average particle size, the use ratio between the core particles and the shell particles, the material of the core particles, the material of the shell particles and others, and then end the spraying of the adhesion aiding agent from the spraying section, for example, at the time when most of the shell particles in the container adhere onto the core particles.

The coating of the core particles with the shell particles may be carried out by means of a surface reforming apparatus equipped with a container in which the core particles are received, and a spraying section for spraying a mixture of the shell particles and the adhesion aiding agent into the container. The surface reforming apparatus may be equivalent to the device except that the mixture of the adhesion aiding agent and the shell particles are stored in the adhesion aiding agent storing portion.

The coating of the core particles with the shell particles by means of this surface reforming apparatus is carried out as follows: First, the core particles are charged into the container, and then the mixture of the adhesion aiding agent and the shell particles is sprayed into the container in the state that the core particles are stirred by the stirring section. When the adhesion aiding agent is sprayed onto the core particles and further thermal energy is given thereto by the stirring, the core particle surfaces swell and soften so that the wettability is improved. The shell particles are mixed with the adhesion aiding agent, and the shell particles mixed therewith are sprayed into the container; thereafter, thermal energy is given to the shell particles while the particles are stirred. Thus, the surfaces of the shell particles swell and soften in the same manner as the surfaces of the core particles. Mechanical impact based on the stirring section is given to the shell particles so that the shell particles are fixed and bonded to the surface of the respective core particles and further a part of a shell particle is melt-bonded to at least one of the core particle and another shell particle adjacent thereto of the shell particles. In this way, the shell particles can be caused to adhere onto the whole of the surfaces of the existing core particles so that the shell particles can be melt-bonded onto the whole of the surfaces of the core particles.

When the mixture of the adhesion aiding agent and the shell particles is sprayed, it is preferred to use the adhesion aiding agent in a proportion of 1 part by weight or more and 99 parts by weight or less with respect to 1 part by weight of the shell particles. The mixture of the adhesion aiding agent and the shell particles, which is a coating liquid, is beforehand prepared in the shell-particle-and-adhesion-aiding-agent preparation step of Step s2. When the mixture of the shell particles and the adhesion aiding agent is sprayed from a single spraying section, the use of the shell particles and the adhesion aiding agent in the proportion makes it possible to heighten the wettability of the shell particles to the core particles sufficiently and further shorten the time when the adhesion aiding agent is removed. Moreover, the viscosity of the mixture is appropriate, and thus the mixture is easily sprayed from the spraying section. When the proportion of the adhesion aiding agent is less than 1 part by weight, the viscosity of the mixture becomes too high so that nozzle holes in the spraying section may be choked. When the proportion of the adhesion aiding agent is more than 99 parts by weight, the content by percentage of the adhesion aiding agent becomes too high so that the time when the adhesion aiding agent is removed becomes too long.

The usage of the mixture of the shell particles and the adhesion aiding agent is not particularly limited as long as the amount is an amount permitting the mixture to contain the shell particles for covering the whole of the surfaces of the core particles. The amount is preferably 1 part by weight or more and 30 parts by weight or less with respect to 100 parts by weight of the core particles in the same manner as described above; therefore, the usage of the mixture is decided in accordance with the content by percentage of the shell particles.

When the coating of the whole of the surfaces of the core particles with the shell particles is terminated, the adhesion aiding agent is removed. The removal of the adhesion aiding agent is carried out by vaporizing the adhesion aiding agent using, for example, a drier. The drier may be an ordinarily-used drier such as a hot-wind heat-received type drier, a conductive heat transfer type drier, or a freeze drier. The adhesion aiding agent may be removed by natural drying.

As described above, the toner of the invention is obtained.

External additives may be added to the toner of the invention, the additives having functions of improving the powdery fluidity, the frictional charging property, the heat resistance, the storage stability over a long term and the cleanability of the toner, controlling the surface abrasive property of a photoreceptor, and attaining others. The external additives may be known ones. Examples thereof include silica fine powder, titanium oxide fine powder, aluminum fine powder, and the like. These powders are preferably subjected to surface treatment with a silicone resin, a silane coupling agent, or some other compound. The external additives may be used each alone, or two or more of them may be used in combination. The addition amount of the external additive(s) is preferably from 0.1 to 10 parts by weight with respect to 100 parts by weight of the toner, considering the charge amount necessary for the toner, an effect of the addition of the additive (s) onto the abrasion of a photoreceptor, environmental characteristics of the toner, and others.

The toner of the invention may be used as a one-component developer or a two-component developer. In the case of using the toner as a one-component developer, only the toner is used without using any carrier. In this case, a blade and a fur brush are used to charge the toner frictionally with a developing sleeve to cause the toner to adhere onto the sleeve. In this way, the toner is carried to form an image. In the case of using the toner of the invention as a two-component toner, the toner is used together with a carrier.

As the carrier, known magnetic particles may be used. Specific examples of the material of the magnetic particles include metals such as iron, ferrite and magnetite; alloys made of one or more of these metals and aluminum, lead or some other metal; and the like. Among these materials, ferrite is preferred.

The following may be used as the carrier: for example, a resin covered carrier, wherein magnetic particles are covered with a resin, a resin dispersed carrier, wherein magnetic particles are dispersed in a resin, or the like. The resin for covering the magnetic particles is not particularly limited, and examples thereof include olefin resins, styrene based resins, styrene/acrylic resins, silicone resins, ester resins, fluorine-contained polymeric resins, and the like. The resin used for the resin dispersed carrier is not particularly limited, and examples thereof include styrene/acrylic resin, polyester resins, fluorine-contained resins, and phenolic resins.

The shape of the carrier is preferably a spherical shape or a flat shape. The particle size of the carrier is not particularly limited. In order to obtain a high image quality, the particle size is preferably from 10 to 100 μm, more preferably from 20 to 50 μm. The resistivity of the carrier is preferably 10⁸ Ω·cm or more, more preferably 10¹² Ω·cm or more. The resistivity of the carrier is a value obtained by putting the carrier into a container having a sectional area of 0.50 cm², tapping the carrier, applying a load of 1 kg/cm² to particles of the carrier filled into the container, applying a voltage at which an electric field of 1,000 V/cm is generated to the member for applying the load and an electrode on the bottom face across the member and the electrode, and then reading out the current value at the time. In the case where the resistivity is low, charges are injected when a bias voltage is applied to the developing sleeve so that the carrier particles adhere easily to the photoreceptor. Moreover, breakdown of the bias voltage is easily caused.

The magnetization intensity (maximum magnetization) of the carrier is preferably from 10 to 60 emu/g, more preferably from 15 to 40 emu/g. When the magnetization intensity is less than 10 emu/g under the condition of ordinary magnetic flux densities of a developing roller, magnetic constraint force may not act to cause carrier-scattering although this phenomenon depends on the magnetic flux density of the developing roller. When the magnetization intensity is more than 60 emu/g, it is difficult to keep a noncontact state between the carrier and an image bearing member in noncontact development, wherein ears of the carrier become too high. Moreover, in contact development, sweep-like marks may easily make their appearance in the toner image.

The use ratio between the toner and the carrier in the two-component developer is not particularly limited, and may be appropriately selected in accordance with the kinds of the toner and the carrier. In a resin covering carrier (density: 5 to 8 g/cm²) as an example, the toner is used in such a manner that the toner is contained at a ratio of 2 to 30% by weight, preferably 2 to 20% by weight of the total of the developer. In the two-component developer, the cover ratio of the carrier with the toner is preferably from 40 to 80%.

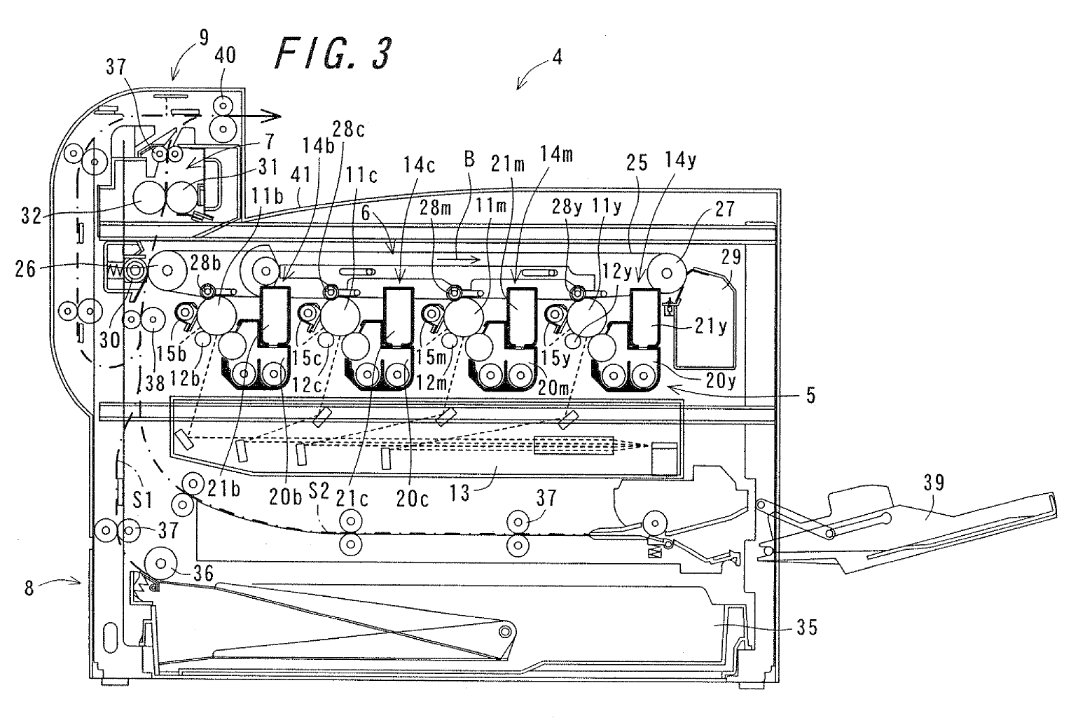

FIG. 3 is a view which schematically illustrates the structure of an image forming apparatus 4 of the invention. The image forming apparatus 4 is a multifunction printer which has a copying function, a printing function and a facsimileing function together, and which is capable of forming full-color or monochrome images on a recording medium in accordance with transmitted image data. Specifically, in the image forming apparatus 4 has three printing modes of a copying mode, a printer mode, and a fax mode. In accordance with operation inputs from an operation portion (not shown), reception of printing job signals from a personal computer, a portable terminal device, an information recording memory medium and an external instrument using a memory device, and others, one of the printing modes is selected through a control unit (not shown). The image forming apparatus 4 includes a toner image forming section 5, a transfer section 6, a fixing section 7, a recording medium feeding section 8, and a discharging section 9. In order to deal with image data on different colors: black (b); cyan (c); magenta (m); and yellow (y) included in color image data on an individual basis, the members constituting the toner image forming section 5 and part of the members included in the transfer section 6 are each correspondingly four in number. Herein, the four pieces of the constituent members of similar kind are distinguishable according to the alphabetical suffixes indicating their respective colors added to the reference symbols, and collectively, they are represented only by the reference symbols.

The toner image forming section 5 includes a photoreceptor drum 11, a charging portion 12, an exposure unit 13, a developing device 14, and a cleaning unit 15. The charging portion 12, the developing device 14 and the cleaning unit 15 are arranged, in this order, around the photoreceptor drum 11. The charging portion 12 is arranged below the developing device 14 and the cleaning unit 15.

The photoreceptor drum 11 is supported by a driving section (not shown), so as to be rotatably driven about an axis thereof, and includes a conductive substrate, and a photosensitive layer formed on the surface of the substrate, each of which is not shown. The conductive substrate may be made into various forms, for example, a cylindrical form, a columnar form, a thin film or sheet form, and the like. Among these forms, a cylindrical form is preferred. The substrate is made of a conductive material. The material may be a conductive material that is ordinarily in the field. The conductive substrate may be made of a metal such as aluminum, copper, brass, zinc, nickel, stainless steel, chromium, molybdenum, vanadium, indium, titanium, gold or platinum; an alloy made of one or more of the metals; a conductive film wherein a conductive layer made of two or more out of aluminum, aluminum alloy, tin oxide, gold, indium oxide and others is formed on a film-form base material such as a synthetic resin film, a metal film, or a paper piece; a resin composition containing conductive particles and/or an conductive polymer; or the like. The film-form base material used in the conductive film is preferably a synthetic resin film, in particular preferably a polyester film. The method for forming the conductive layer in the conductive film is preferably vapor deposition, coating or the like.

The photosensitive layer is formed, for example, by laminating a charge generating layer containing a charge generating substance and a charge transporting layer containing a charge transporting substance onto each other. At this time, it is preferred to form an undercoat layer between the conductive substrate and the charge generating layer or the charge transporting layer. The formation of the undercoat layer produces advantageous effects that injures and irregularities present in the surface of the conductive substrate are covered so that the surface of the photosensitive layer is made flat and smooth; the charging characteristics of the photosensitive layer are prevented from being deteriorated when the photoreceptor is repeatedly used; and the charging characteristics of the photosensitive layer is improved in a low-temperature and/or low-humidity environment. The photosensitive layer may be a laminated photosensitive layer having a three-layer structure wherein a layer for protecting the photoreceptor surface is formed as the topmost layer to exhibit a large durability.

The charge generating layer contains, as a main component, a charge generating substance which is irradiated with light to generate charges, and optionally contains known additives such as a binder resin, a plasticizer, and a sensitizer. The charge generating substance may be a substance that is ordinarily used in the field, and examples thereof include perylene pigments such as perylene imide and perylene acid anhydride, polycyclic quinone pigments such as quinacridon and anthraquinone, phthalocyanine pigments such as metal and metal-free phthalocyanines and halogenated metal-free phthalocyanines, squarerium dyes, azulenium dyes, thiapyrylium dyes, azo pigments having a carbazole skeleton, a styrylstylbene skeleton, a triphenylamine skeleton, a dibenzothiophene skeleton, an oxadiazole skeleton, a fluorenone skeleton, a bisstylbene skeleton, a distyryloxadiazole skeleton or a distyrylcarbazole skeleton, and the like. Among these substances, metal-free phthalocyanlne pigments, oxotitanylphthalocyanine pigments, bisazo pigments containing a fluorene ring and/or a fluorenone ring, bisazo pigments each made of an aromatic amine, trisazo pigments are suitable for obtaining a high-sensitivity photosensitive layer since they have a high capability of generating charges. The charge generating substances may be used each alone, or two or more of them may be used in combination. The content of the charge generating substance(s) is not particularly limited, and is preferably from 5 to 500 parts by weight, more preferably from 10 to 200 parts by weight with respect to 100 parts by weight of the binder resin in the charge generating layer. The binder resin for the charge generating layer may be a binder resin that is ordinarily used in the field. Examples thereof include melamine resins, epoxy resins, silicone resins, polyurethane, acrylic resins, vinyl chloride-vinyl acetate copolymer resins, polycarbonate, phenoxy resins, polyvinyl butyral, polyarylate, polyamide, polyester, and the like. These binder resins may be used each alone, or two or more of them may be used in combination.

The charge generating layer can be formed by: dissolving or dispersing an appropriate amount of the respective charge generating substance, the binder resin, an optional plasticizer, an optional sensitizer, and optional other components into an appropriate organic solvent wherein these components can be dissolved or dispersed to prepare a charge generating layer coating solution; applying this charge generating layer coating solution to the surface of the conductive substrate; and then drying the resultant. The film thickness of the thus-obtained charge generating layer is not particularly limited, and is preferably from 0.05 to 5 μm, more preferably from 0.1 to 2.5 μm.

The charge transporting layer laminated on the charge generating layer contains, as essential components, a charge transporting material having a capability of receiving charges generated from a charge generating substance and then transporting the charges, and a binder resin for charge transporting layer, and optionally contains known additives such as an antioxidant, a plasticizer, a sensitizer, and a lubricant. The charge transporting substance may be a material that is ordinarily used in the field. Examples thereof include electron-donating substances such as poly-N-vinylcarbazole and derivatives thereof, poly-γ-carbazolylethyl glutamate and derivatives thereof, pyrene-formaldehyde condensed products and derivatives thereof, polyvinylpyrene, polyvinylphenanthrene, oxazole derivatives, oxadiazole derivatives, imidazole derivatives, 9-(p-diethylaminostyryl)anthracene, 1,1-bis(4 dibenzylaminophenyl)propane, styrylanthracene, styrylpyrazoline, pyrazoline derivatives, phenylhydrazones, hydrazone derivatives, triphenylamine compounds, tetraphenyldiamine compounds, triphenylmethane compounds, stylbene compounds, azine compounds each having a 3-methyl-2-benzothiazoline ring; electron-accepting substances such as fluorenone derivatives, dibenzothiophene derivatives, indenothiophene derivatives, phenanthrenequinone derivatives, indenopyridine derivatives, thioxanthone derivatives, benzo[c]cinnoline derivatives, phenazineoxide derivatives, tetracyanoethylene, tetracyanoquinodimethane, bromanil, chloranil, benzoquinone; and the like. The charge transporting substances may be used each alone, or two or more of them may be used in combination. The content of the charge transporting substance(s) is not particularly limited, and is preferably from 10 to 300 parts by weight, more preferably from 30 to 150 parts by weight with respect to 100 parts by weight of the binder resin in the charge transporting layer. The binder resin for charge transporting layer may be a substance that is capable of dispersing the charge transporting material evenly therein and is ordinarily used in the field. Examples thereof include polycarbonate, polyarylate, polyvinyl butyral, polyamide, polyester, polyketone, epoxy resins, polyurethane, polyvinyl ketone, polystyrene, polyacrylamide, phenol resins, phenoxy resins, polysulfone resins, copolymer resins thereof, and the like. Among these resins, polycarbonate containing, as a monomer component, bisphenol Z, which will be referred to as “bisphenol Z type polycarbonate” hereinafter, and a mixture of bisphenol Z type polycarbonate and a different polycarbonate are preferred, considering film-forming capability, the abrasion resistance and electric characteristics of the charge transporting layer obtained therefrom, and other properties. These binder resins may be used each alone, or two or more of them may be used in combination.

The charge transporting layer preferably contains an antioxidant together with the charge transporting substance and the binder resin for charge transporting layer. The antioxidant may be one that is ordinarily used in the field, and examples thereof include vitamin E, hydroquinone, hindered amines, hindered phenols, p-phenylenediamine, arylalkanes and derivatives thereof, organic sulfur compounds, organic phosphorus compounds, and the like. The antioxidants may be used each alone, or two or more of them, may be used in combination. The content of the antioxidant (s) is not particularly limited, and is from 0.01 to 10% by weight, preferably form 0.05 to 5% by weight of the total of the components constituting the charge transporting layer. The charge transporting layer can be formed by: dissolving or dispersing an appropriate amount of the respective charge transporting substance, the binder resin, the optional antioxidant(s), an optional plasticizer, an optional sensitizer, and optional other components into an appropriate organic solvent wherein these components can be dissolved or dispersed to prepare a charge transporting layer coating solution; painting this charge transporting layer coating solution onto the surface of the charge generating layer; and then drying the resultant. The film thickness of the thus-obtained charge transporting layer is not particularly limited, and is preferably from 10 to 50 μm, more preferably from 15 to 40 μm. A single photosensitive layer containing both of the charge generating substance and the charge transporting substance may be formed. In this case, the kinds of the charge generating substance and the charge transporting substance, the contents thereof, the kind of the binder resin, other additives, and others may be the same as in the case of forming the charge generating layer and the charge transporting layer separately.

In the embodiment, a photoreceptor drum on which an organic photosensitive layer containing a charge generating substance and a charge transporting substance is formed is used, as describe above. Instead of the photoreceptor drum, however, a photoreceptor drum on which an inorganic photosensitive layer containing silicon or the like is formed may be used.

The charging portion 12 is arranged so as to face the photoreceptor drum 11 and be separated from the surface of the photoreceptor drum 11 along the longitudinal direction of the photoreceptor drum 11, and causes the surface of the photoreceptor drum 11 to be charged into a predetermined polarity and a predetermined electric potential. For the charging portion 12, a brush type charging device, a charger type charging device, a pin-array type charging device, an ion generator, or the like may be used. In the embodiment, the charging portion 12 is arranged to be separated from the surface of the photoreceptor drum 11; however, the portion 12 is not limited to this structure or arrangement. For example, it is allowable to use a charging roller as the charging portion 12 and arrange the charging roller so as to be in pressure-contact with the photoreceptor drum 11, or use a charging device of contact-charging type, such as a charging brush or a magnetic brush.

The exposure unit 13 is arranged in such a manner that a light beam according to each of color data emitted from this unit 13 is passed between the charging portion 12 and the developing device 14 and is shone on the surface of the photoreceptor drum 11. In the exposure unit 13, image data are converted into light beams according to data on the respective colors b, c, m and y in the unit 13, and the surface of the photoreceptor drum 11 charged into a constant electric potential by means of the charging portion 12 is exposed to the light beams according to the respective color data, so as to form electrostatic latent images on the surface. The exposure unit 13 may be, for example, a laser scanning unit equipped with a laser radiating section and reflecting mirrors, or a unit wherein an LED array, a liquid crystal shutter, and a light source are appropriately combined with each other.

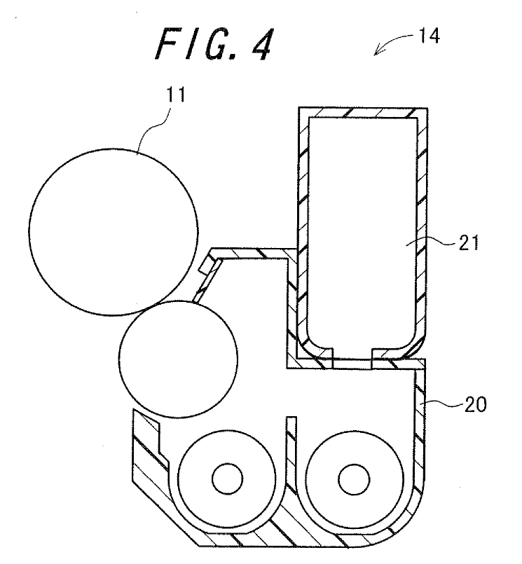

FIG. 4 is a schematic view illustrating the structure of the developing device 14. The developing device 14 includes a developing tank 20 and a toner hopper 21. The developing tank 20 is arranged to face the surface of the photoreceptor drum 11, and is a member, in the form of a container, for supplying a toner onto an electrostatic latent image formed on the surface of the photoreceptor drum 11, thereby developing the latent image to form a toner image, which is a visible image. The developing tank 20 receives, in its inner space, toner and further receives, in the space, roller members such as a developing roller, a supplying roller and a stirring roller, or screw members, so as to support the members rotatably. An opening is made in a side face of the developing tank 20 which faces the photoreceptor drum 11, and the developing roller is set up to be rotatably driven at a position opposing to the photoreceptor drum 11 across this opening. The developing roller is a member in a roller form for supplying toner onto an electrostatic latent image on the surface of the photoreceptor drum 11 at a portion where it is brought into pressure-contact with or closest proximity to the photoreceptor drum 11. In the supply of the toner, an electric potential having a polarity reverse to the polarity of the electric potential of the charged toner is applied as a developing bias voltage, which will be referred to merely as a “developing bias” hereinafter, to the surface of the developing roller. In this way, the toner on the surface of the developing roller is smoothly supplied onto the electrostatic latent image. Furthermore, when the developing bias value is varied, the toner amount (toner attachment amount) supplied onto the electrostatic latent image can be controlled. The supplying roller is a member in a roller form which is set up to face the developing roller and be rotatably driven, and the roller supplies toner to the vicinity of the developing roller. The stirring roller is a member in a roller form which is arranged to face the supplying roller and be rotatably driven. The roller supplies the toner supplied newly from the toner hopper 21 into the developing tank 20 to the vicinity of the supplying roller. The toner hopper 21 is set up in such a manner that a toner supplying opening made in a lower portion of the hopper 21 is connected to a toner receiving opening made in an upper portion of the developing tank 20, and supplies toner in accordance with the toner consumption situation of the developing tank 20. It is allowable to supply, from individual color-toner-cartridges, color toners directly without using the toner hopper 21.

After a toner image formed as described above is transferred onto a recording medium, the cleaning unit 15 removes the toner remaining on the surface of the photoreceptor drum 11 to clean the surface. The cleaning unit 15 may be, for example, a plate-like member such as a cleaning blade. In the image forming apparatus 4 of the invention, an organic photoreceptor drum is mainly used as the photoreceptor drum 11, and the surface of the organic photoreceptor drum is mainly made of a resin component; therefore, a deterioration in the surface is easily advanced by chemical action of ozone generated by corona discharge based on the charging portion. However, the deteriorated surface region is worn away by rubbing-effect of the cleaning unit 15, so that the region is slowly but surely removed. Accordingly, a problem that the surface is deteriorated by ozone or the like is actually overcome, and the electrostatic potential based on charging operation can stably be maintained for a long term. In the embodiment, the cleaning unit 15 is set up; however, the cleaning unit 15 may not be set up.

According to the toner image forming section 5, signal light corresponding to image data is radiated from the exposure unit 13 onto the surface of the photoreceptor drum 11 turned in an even charged state by effect of the charging portion 12, so as to form an electrostatic latent image. Toner is supplied thereto from the developing device 14 to form a toner image. This toner image is transferred onto an intermediate transfer belt 25, and then the toner remaining on the surface of the photoreceptor drum 11 is removed by the cleaning unit 15. The series of the toner image forming operations are repeatedly carried out.

The transfer section 6 is arranged above the photoreceptor drum 11, and includes the intermediate transfer belt 25, a driving roller 26, a driven roller 27, an intermediate transfer roller 28 (b, c, m and y), a transfer belt cleaning unit 29, and a transfer roller 30. The intermediate transfer belt 25 is a member in an endless belt form which is stretched between the driving roller 26 and driven roller 27, so as to form a loop-form moving route, and is rotated into the direction of an arrow B, when the intermediate transfer belt 25 is passed on the photoreceptor drum 11 to be brought into contact with the drum 11, a transfer bias having a polarity reverse to the polarity of the toner charged on the surface of the photoreceptor drum 11 is applied from the intermediate transfer roller 28 arranged oppositely, across the intermediate transfer belt 25, to the photoreceptor drum 11. The toner image formed on the surface of the photoreceptor drum 11 is transferred onto the intermediate transfer belt 25. In the case of a full color image, toner images in the individual colors formed on the individual photoreceptor drums 11b, 11c, 11m and 11y are successively transferred into a stack state onto the intermediate transfer belt 25, thereby forming a full color toner image. The driving roller 26 is set up to be rotatably driven about an axis thereof by a driving section (not shown). By the rotational driving, the intermediate transfer belt 25 is rotationally driven into the direction of the arrow B. The driven roller 27 is set up to be rotatably trailed by the rotational driving of the driving roller 26, and gives a predetermined tension to the intermediate transfer belt 25 so as not to slack the belt 25. The intermediate transfer roller 28 is brought into pressure-contact with the photoreceptor drum 11, with the intermediate transfer belt 25 lying therebetween, and is further rotatably driven about an axis thereof by a driving section (not shown). To the intermediate transfer roller 28 is connected a power source (not shown) for applying a transfer bias, as described above. The roller 28 has a function of transferring any toner image on the surface of the photoreceptor drum 11 onto the intermediate transfer belt 25. The transfer belt cleaning unit 29 is set to oppose to the driven roller 27 across the intermediate transfer belt 25 and contact the outer circumferential face of the intermediate transfer belt 25. Toner adhered onto the intermediate transfer belt 25 by the contact of the belt 25 with the photoreceptor drum 11 causes pollution on the rear surface of a recording medium; thus, the transfer belt cleaning unit 29 removes and collects the toner on the surface of the intermediate transfer belt 25. The transfer roller 30 is brought into pressure-contact with the driving roller 26, with the intermediary transfer belt 25 lying therebetween, and is rotatably driven about an axis thereof by a driving section (not shown). In a pressure-contact portion between the transfer roller 30 and the driving roller 26 (transfer nip portion), a toner image borne on the intermediate transfer belt 25 and transported thereby is transferred onto a recording medium fed from the recording medium feeding section 8, which will be detailed later. The recording medium on which the toner image is carried is fed to the fixing section 7. According to the transfer section 6, a toner image transferred from the photoreceptor drum 11 onto the intermediate transfer belt 25 in the pressure-contact portion between the photoreceptor drum 11 and the intermediate transfer roller 28 is transported to the transfer nip portion by the rotational driving of the intermediate transfer belt 25 in the direction of the arrow B, and then the toner image is transferred onto the recording medium in the transfer nip portion.

The fixing section 7 is arranged at the downstream side of the transfer section 6 in the conveying direction of the recording medium, and includes a fixing roller 31 and a pressure roller 32. The fixing roller 31 is set to be rotatably driven by a driving section (not shown), and heats the toner which constitutes the toner image borne on the recording medium, which is not yet fixed, so as to melt the toner. As a result, the toner image is fixed on the recording medium. Inside the fixing roller 31, a heating section (not shown) is set up. The heating section heats the fixing roller 31 to turn the surface of the fixing roller 31 into a predetermined temperature (heat temperature). In the heating section, for example, a heater, or a halogen lamp may be used. The heating section is controlled by a fixing condition control section, which will be described later also. The control of the heat temperature by the fixing condition control section will be detailed later. A temperature detecting sensor is set near the surface of the fixing roller 31 and detects the surface temperature of the fixing roller 31. Results detected with the temperature detecting sensor are written in a memory portion of a control unit, which will be detailed later. The pressure roller 32 is disposed so as to be brought into pressure-contact with the fixing roller 31, and is supported to be rotated by the rotational driving of the fixing roller 31. When the toner is melted and fixed onto a recording medium by the fixing roller 31, the pressure roller 32 presses the toner against the recording medium, thereby assisting the toner image in fixing onto the recording medium. The pressure-contact portion between the fixing roller 31 and the pressure roller 32 is a fixing nip portion. According to the fixing section 7, a recording medium on which the toner is transferred in the transfer section 6 is sandwiched between the fixing roller 31 and the pressure roller 32. When the recording medium is passed through the fixing nip portion, the toner image is pressed against the recording medium while the toner image is heated. In this way, the toner image is fixed on the recording medium to form an image.

The recording medium feeding section 8 includes an automatic paper feed tray 35, a pickup roller 36, conveying rollers 37, registration rollers 38, and a manual paper feed tray 39. The automatic paper feed tray 35 is arranged in a lower portion of the image forming apparatus 4, and is a member for storing recording mediums, Examples of the recording mediums include plain paper, color copying paper, sheets for overhead projectors, postcards. The pickup roller 36 takes out the recording mediums stored in the automatic paper feed tray 35 one by one, and feeds the taken-out medium to a paper conveyance path S1. The conveying rollers 37 are a pair of roller members which are arranged to be brought into pressure-contact with each other, and convey the recording medium toward the registration rollers 38. The registration rollers 38 are a pair of roller members which are arranged to be brought into pressure-contact with each other, and feed the recording medium fed from the conveying rollers 37 in synchronization with the conveyance of toner images borne on the intermediate transfer belt 25 to the transfer nip portion. The manual paper feed tray 39 is a device storing recording mediums which are different from the recording mediums stored in the automatic paper feed tray 35 and may have any size and which are to be taken into the image forming apparatus 100. The recording medium taken in from the manual paper feed tray 39 is made to pass through a paper conveyance path S2 by means of the conveying rollers 37 and fed to the registration rollers 38. According to the recording medium feeding section 5, the recording mediums fed from the automatic paper feed tray 35 or the manual paper feed tray 39 one by one are supplied to the transfer nip portion in synchronism with the conveyance of the toner image borne on the intermediate transfer belt 25 to the transfer nip portion.

The discharging section 9 includes conveying rollers 37, discharging rollers 40, and a catch tray 41. The conveying rollers 37 are arranged at the downstream side of the fixing nip portion in the paper conveying direction, and convey each recording medium on which an image is fixed by the fixing section 7 toward the discharging rollers 40. The discharging rollers 40 discharge the recording medium, on which the image is fixed, into the catch tray 41 arranged on the upper surface of the image forming apparatus 4. The catch tray 41 stores the recording mediums on which the image is fixed.

The control unit (not shown) is included in the image forming apparatus 4. The control unit is set up in an upper portion of a space inside the image forming apparatus 4, and includes, for example, a memory portion, a computing portion, and a control portion. Into the memory portion in the control unit are inputted various values set through an operating panel (not shown) arranged on the upper surface of the image forming apparatus 4 and detection results from sensors arranged at various positions inside the image forming apparatus 4, image data from an external instrument, and other data. Moreover, programs for carrying out various functional elements are written in the memory portion. The various functional elements are, for example, a recording medium detecting section, an attachment amount control section, and the fixing condition control section. The memory portion may be one that is ordinarily used in the field. Examples thereof include a read-only memory (ROM), a random access memory (RAM), a hard disc driver (HDD), and the like. The external instrument may be an electrical/electronic instrument capable of forming or gaining image data and being connected electrically to the image forming apparatus 4. Examples thereof include a computer, a digital camera, a television, a video recorder, a digital versatile disc (DVD) recorder, a high-definite on digital versatile disc (HDDVD), a blu-ray disc recorder, a facsimile, a portable terminal, and the like. The computing portion takes out various data (such as image forming commands, detection results, and image data) and the programs for the various functional components, and makes various determinations. In accordance with results of the determinations of the computing portion, the control portion sends control signals to the corresponding sections, and performs operation-controls. The control portion and the computing portion include a processing circuit realized by a microcomputer or a microprocessor having a central process unit (CPU), or the like. The control unit contains a main power source besides the processing circuit, and supplies electric power to not only the control unit but also the individual sections inside the image forming apparatus 4.

When the toner of the invention is used to form an image, the following is prevented: the toner spent to a carrier is generated, and the charging characteristics of the developer deteriorates accordingly. Thus, the toner can stably keep good fluidity, anti-blocking property and charging stability over a long term. As a result, high-quality images having a high resolution can be formed.

### EXAMPLES

The invention will be specifically described by way of the following Examples and Comparative Examples; however, the invention is not limited to these Examples, and may be modified as long as the modification does not depart from the subject matter of the invention. In the following description, the word “part(s)” and the symbol “%” mean “parts by weight” and “% by weight”, respectively, unless otherwise specified. In the Examples and the Comparative Examples, physical values of components were measured as follows.

[Projection Average Particle Size A]

A photograph of toner particles wherein cover layers were formed was taken at a magnification power of 10,000 with an electron microscope (trade name: VE-9800, manufactured by Keyence Corp.). In the taken photograph of the toner particles, the following were measured; the short size A1 and the long size A2 of a projection that was contained in a circle having a center at a central portion of the toner particles and having a radius of 1.5 μm (1.5 cm in the photograph) and was present in a region contained in the toner particles. The average of the short size A1 and the long size A2, that is, the average size {(A1+A2)/2} was calculated. Furthermore, such averages were calculated about a plurality of other projections present in plural circles in the photographic toner image. The average of the calculated values was then obtained. The thus-calculated value was defined as the projection average particle size A.

[Core Average Particle Size B]

A photograph of core particles of the toner particles was taken at a magnification power of 5,000 with the electron microscope. From this taken photograph, the short size B1 and the long size B2 of one of the core particles were measured. The average of the short size B1 and the long size B2, that is, the average particle size {(B1+B2)/2} was then calculated. Furthermore, such average particle sizes were calculated about a plurality of other core particles present in a plurality of circles in the photographic toner image. The average of these values was calculated. The thus-calculated value was defined as the core average particle size B.

[Volume Particle Size Distribution, Number Particle Size Distribution, Volume Average Particle Size, Number Average Particle Size, and Coefficient of Variation (CV Value)]

To 50 ml of an electrolytic solution (trade name: ISOTON-II, manufactured by Beckman Coulter Inc.) were added 20 mg of a sample and 1 ml of sodium alkylethersulfate, and then using an ultrasonic disperser (trade name: UH-50, manufactured by SMT Co., Ltd.), the resultant mixture was subjected to dispersing treatment at an ultrasonic frequency of 20 kHz for 3 minutes to prepare a measuring sample. About this measuring sample, a particle size distribution measuring device (trade name: MULTISIZER 3, manufactured by Beckman Coulter Inc.) was used to make measurements under the following conditions: aperture diameter: 100 μm; and the number of particles to be measured: 50,000 counts. From the volume particle size distribution and the number particle size distribution of the measured particles, the volume average particle size and the number average particle size were then obtained. Moreover, the coefficient of variation of the toner particles was calculated on the basis of the volume average particle size and the standard deviation thereof in accordance with the following expression (1):

Coefficient of variation=Standard deviation/Volume average particle size (1)

[Glass Transition Temperature (Tg) of Hinder Resin]

A differential scanning calorimeter (trade name: DSC220, manufactured by Seiko Instruments Ltd.) was used to heat 1 g of a sample at a temperature-raising rate of 10° C. per minute in accordance with the Japanese Industrial Standard (JIS) K 7121-1987 so as to obtain a DSC curve of the sample. About an endothermic peak corresponding to the glass transition temperature of the obtained DSC curve, its base line at the side of higher temperatures was extended toward the side of lower temperatures to give a straight line, and further a tangent line was drawn onto a curve from a rise point of the peak to the apex thereof at a point where the gradient of the tangent line was made maximum. The temperature at the intersection of the straight line and the tangent line was obtained as the glass transition temperature (Tg).

[Softening Temperature (Tm) of Binder Resin]

In a flow characteristic evaluating device (trade name: FLOW TESTER CFT-100 C, manufactured by Shimadzu Corp.), a load of 10 kgf/cm² (9.8×10⁵ Pa) was given to a sample so as to set a condition that 1 g of the sample was pushed out from a die (nozzle diameter: 1 mm, and length thereof: 1 mm). The sample was heated at a temperature-raising rate of 6° C. per minute, and the temperature when a half amount of the sample was pushed out from the die was measured. The temperature was defined as the softening temperature.

[Melting Point of Release Agent]

A differential scanning calorimeter (trade name: DSC220, manufactured by Seiko Instruments & Electronics Ltd.) was used to raise the temperature of 1 g of a sample from 20° C. to 200° C. at a temperature-raising rate of 10° C. per minute. Next, the sample was rapidly cooled from 200° C. to 20° C. This operation was repeated twice. In this way, DSC curves were obtained. The temperature at the apex of an endothermic peak of the DSC curve obtained by the second operation, the peak corresponding to melting, was defined as the melting point of the release agent.

### Example 1

### Core Particle Preparation Step

The following were mixed in a mixing machine (trade name: HENSCHELMIXER, manufactured by Mitsui Mining Co., Ltd.) for 3 minutes to obtain a raw material: 85 parts of a polyester resin (trade name: TUFTONE, manufactured by Kao Corporation; glass transition temperature: 70° C., and softening temperature: 130° C.) as a binder resin; 5 parts of copper phthalocyanine (C.I. Pigment Blue 15:3) as a colorant; 8 parts of a release agent (carnauba wax; melting point: 82° C.); and 2 parts of a charge control agent (trade name; BONTRON E84, manufactured by Orient Chemical Industries Ltd.). A biaxial extruder (trade name: PCM-30, manufactured by Ikegai, Ltd.) was used to melt-knead the resultant raw material to prepare a resin kneaded product. Conditions for the driving of the biaxial extruder were as follows: the set cylinder temperature was 110° C., the barrel rotating number was 300 revolutions per minute (300 rpm), and the raw material supplying rate was 20 kg/hour.

The resultant kneaded toner product was cooled on a cooling belt, and then pulverized into coarse particles by means of a speed mill having a screen having pores 2 mm in diameter.

The resultant coarsely-pulverized product was pulverized by means of a jet pulverizer (trade name: IDS-2, manufactured by Nippon Pneumatic Mfg. Co., Ltd.), and further the resultant was supplied to a classifier (trade name: ELBOW JET CLASSIFIER, manufactured by Nittetsu Mining Co., Ltd.) to remove microfine particles and coarse particles, thereby obtaining core particles having a core average particle size of 4.5 μm and a coefficient of variation of 26.

[Shell-Particle-and-Adhesion-Aiding-Agent Preparation Step]

As shell particles A, prepared were styrene-butyl acrylate copolymer fine particles A (glass transition temperature: 80° C., and softening temperature: 128° C.) having a volume average particle size of 0.2 μm. The shell particles A were obtained by subjecting a polymer made from styrene and butyl acrylate to freeze-drying.

Ethanol was prepared as an adhesion aiding agent.

[Coating Step]

Into a surface reforming apparatus (trade name: HYBRIDIZER MODEL NHS-1, manufactured by Nara Machinery Co., Ltd.) to which a two-fluid nozzle capable of spraying liquid in its container was fitted were charged 100 parts of the core particles and 10 parts of the shell particles, and then the mixture was retained at a rotation speed of 8,000 rpm for 10 minutes. Thereafter, compressed air was sent to the two-fluid nozzle to adjust the spray amount of ethanol as an adhesion aiding agent into 0.5 g/minute. While the ethanol was sprayed for 40 minutes in this way, the whole of the surfaces of the core particles were coated with the shell particles.

The core particles, having cover layers formed by coating the whole of the surfaces of the core particles with the shell particles, were subjected to freeze-drying to obtain a toner of Example 1. About the toner of Example 1, the toner particles had the volume average particle size of 4.9 μm, and the coefficient of variation of 29.6, and the ratio of toner particles having the number average particle size of 3.0 μm or less to the entirety of the toner particles according to the Coulter Counter was 12.0% by number.

### Example 2

A toner of Example 2 was obtained in the same way as in Example 1 except that the core average particle size was changed. About the toner of Example 2, the toner particles had the volume average particle size of 5.9 μm, and the coefficient of variation of 24.9, and the ratio of toner particles having the number average particle size of 3.0 μm or less to the entirety of the toner particles according to the Coulter Counter was 10.5% by number.

### Example 3

A toner of Example 3 was obtained in the same way as in Example 1 except that the core average particle size was changed. About the toner of Example 3, the toner particles had the volume average particle size of 5.3 μm, and the coefficient of variation of 25.0, and the ratio of toner particles having the number average particle size of 3.0 μm or less to the entirety of the toner particles according to the Coulter Counter was 13.1% by number.

### Example 4

A toner of Example 4 was obtained in the same way as in Example 1 except that the core average particle size was changed. About the toner of Example 4, the toner particles had the volume average particle size of 4.9 μm, and the coefficient of variation of 33.9, and the ratio of toner particles having the number average particle size of 3.0 μm or less to the entirety of the toner particles according to the Coulter Counter was 15.8% by number.

### Example 5

A toner of Example 5 was obtained in the same way as in Example 1 except that the shell-particle-and-adhesion-aiding-agent preparation step and the coating step were changed as described below. About the toner of Example 5, the toner particles had the volume average particle size of 4.8 μm, and the coefficient of variation of 30.3, and the ratio of toner particles having the number average particle size of 3.0 μm or less to the entirety of the toner particles according to the Coulter Counter was 11.8% by number.

[Shell-Particle-and-Adhesion-Aiding-Agent Preparation Step]

As shell particles B, prepared were styrene-butyl acrylate copolymer fine particles B (glass transition temperature: 67° C., and softening temperature: 165° C.) having a volume average particle size of 0.2 μm. The shell particles B were obtained by subjecting a polymer made from styrene and butyl acrylate to freeze-drying.

Ethanol was prepared as an adhesion aiding agent.

[Coating Step]

A homogenizer (trade name: POLYTRON PT-MR3100, manufactured by KINEMATICA AG) was used to agitate and mix 15 parts of the shell particles B and 85 parts of ethanol as an adhesion aiding agent at 8,000 rpm for 20 minutes, thereby preparing a coating liquid wherein the concentration of the shell particles having a volume average particle size of 0.2 μm was 15% by weight.

Into a surface reforming apparatus (trade name: HYBRIDIZER MODEL NHS-1, manufactured by Nara Machinery Co., Ltd.) to which a two-fluid nozzle capable of spraying liquid in its container was fitted was fitted were charged 100 parts of the core particles. While the particles were retained at a rotation speed of 8,000 rpm, compressed air was sent to the two-fluid nozzle to adjust the spray amount of the coating liquid, which was the mixture composed of 15 parts of the shell particles and 85 parts (amount of solids) of ethanol, into 1.0 g/minute. While the coating solution was sprayed for 67 minutes in this way, the whole of the surfaces of the core particles were coated with the shell particles.

### Example 6

A toner of Example 6 was obtained in the same way as in Example 1 except that the shell-particle-and-adhesion-aiding-agent preparation step was changed as described below. About the toner of Example 6, the toner particles had the volume average particle size of 4.7 μm, and the coefficient of variation of 30.0, and the ratio of toner particles having the number average particle size of 3.0 μm or less to the entirety of the toner particles according to the Coulter Counter was 10.8% by number.

[Shell-Particle-and-Adhesion-Aiding-Agent Preparation Step]

As shell particles C, prepared were styrene-butyl acrylate copolymer fine particles C (glass transition temperature: 74° C., and softening temperature: 122° C.) having a volume average particle size of 0.1 μm. The shell particles C were obtained by subjecting a polymer made from styrene and butyl acrylate to freeze-drying.

Ethanol was prepared as an adhesion aiding agent.

### Example 7

A toner of Example 7 was obtained in the same way as in Example 1 except that the shell-particle-and-adhesion-aiding-agent preparation step was changed as described below. About the toner of Example 7, the toner particles had the volume average particle size of 4.9 μm, and the coefficient of variation of 30.3, and the ratio of toner particles having the number average particle size of 3.0 μm or less to the entirety of the toner particles according to the Coulter Counter was 12.0% by number.

[Shell-Particle-and-Adhesion-Aiding-Agent Preparation Step]

As shell particles D, prepared were styrene-butyl acrylate copolymer fine particles D (glass transition temperature: 85° C., and softening temperature: 134° C.) having a volume average particle size of 0.5 μm. The shell particles D were obtained by dissolving the polymeric resin into methyl ethyl ketone, mixing this solution with a solution of a nonionic surfactant (polyvinyl alcohol) in water, emulsifying the mixture by means of a homogenizer (trade name: POLYTRON PT-MR3100, manufactured by KINEMATICA AG), distilling methyl ethyl ketone off from the emulsion, and further subjecting the emulsion to freeze-drying.

Ethanol was prepared as an adhesion aiding agent.

### Comparative Example 1

A toner of Comparative Example 1 was obtained in the same way as in Example 1 except that the core average particle size was changed and the coating step by use of shell particles was not carried out. About the toner of Comparative Example 1, the toner particles had the volume average particle size of 5.5 μm, and the coefficient of variation of 24.0, and the ratio of toner particles having the number average particle size of 3.0 μm or less to the entirety of the toner particles according to the Coulter Counter was 7.0% by number.

### Comparative Example 2

A toner of Comparative Example 2 was obtained in the same way as in Example 1 except that the core average particle size was changed and the coating step by use of shell particles was not carried out. About the toner of Comparative Example 2, the toner particles had the volume average particle size of 5.9 μm, and the coefficient of variation of 41.8, and the ratio of toner particles having the number average particle size of 3.0 μl or less to the entirety of the toner particles according to the Coulter Counter was 30.0% by number.

### Comparative Example 3

A toner of Comparative Example 3 was obtained in the same way as in Example 1 except that the core average particle size was changed. Aggregates were mingled in a large amount into the toner of Comparative Example 3. The toner particles had the volume average particle size of 5.9 μm, and the coefficient of variation of 42.0, and the ratio of toner particles having the number average particle size of 3.0 μm or less to the entirety of the toner particles according to the Coulter Counter was 30.0% by number.

### Comparative Example 4

A toner of Comparative Example 4 was obtained in the same way as in Example 1 except that the coating step was changed as described below. Shell particles which were not adhered onto the resultant toner were present inside the apparatus. About the toner of Comparative Example 4, the toner particles had the volume average particle size of 5.0 μm, and the coefficient of variation of 29, and the ratio of toner particles having the number average particle size of 3.0 μm or less to the entirety of the toner particles according to the Coulter Counter was 10.2% by number.

[Coating Step]

Into a surface reforming apparatus (trade name: HYBRIDIZER MODEL NHS-1, manufactured by Nara Machinery Co., Ltd.) to which a two-fluid nozzle capable of spraying liquid in its container was fitted were charged 100 parts of the core particles. The particles were retained at a rotation number of 8,000 rpm for 10 minutes to coat the whole of the surfaces of the core particles with the shell particles.

### Comparative Example 5

A toner of Comparative Example 5 was obtained in the same way as in Example 1 except that the shell-particle-and-adhesion-aiding-agent preparation step was changed as described below. About the toner of Comparative Example 5, the toner particles had the volume average particle size of 4.6 μm, and the coefficient of variation of 31, and the ratio of toner particles having the number average particle size of 3.0 μm or less to the entirety of the toner particles according to the Coulter Counter was 11.8% by number.

[Shell-Particle-and-Adhesion-Aiding-Agent Preparation Step]

As shell particles E, prepared were styrene-methyl methacrylate copolymer fine particles E (glass transition temperature: 105° C., and decomposition temperature: not lower than 200° C.) having a volume average particle size of 0.07 μm. The shell particles E were obtained by subjecting a polymer made from styrene and methyl methacrylate to freeze-drying.

Ethanol was prepared as an adhesion aiding agent.

### Comparative Example 6

A toner of Comparative Example 6 was obtained in the same way as in Example 1 except that the shell-particle-and-adhesion-aiding-agent preparation step was changed as described below. About the toner of Comparative Example 6, the toner particles had the volume average particle size of 5.2 μm, and the coefficient of variation of 35, and the ratio of toner particles having the number average particle size of 3.0 μm or less to the entirety of the toner particles according to the Coulter Counter was 27.1% by number.

[Shell-Particle-and-Adhesion-Aiding-Agent Preparation Step]

As shell particles F, prepared were styrene-butyl acrylate copolymer fine particles F (glass transition temperature: 85° C., and softening temperature: 134° C.) having a volume average particle size of 0.7 μm. The shell particles F were obtained by dissolving the polymeric resin into methyl ethyl ketone, mixing this solution with a solution of a nonionic surfactant (polyvinyl alcohol) in water, emulsifying the mixture by means of a homogenizer (trade name: POLYTRON PT-MR3100, manufactured by KINEMATICA AG), distilling methyl ethyl ketone off from the emulsion, and further subjecting the emulsion to freeze-drying.

Ethanol was prepared as an adhesion aiding agent.

Conditions for manufacturing the toners of the Examples and the Comparative Examples are shown in Table 1.

TABLE 1

| | | Particle | Glass transition | Softening | |
|---|---|---|---|---|---|
| | Shell particles | size (μm) | temperature (° C.) | temperature (° C.) | Spray |
| Example 1 | Styrene-butyl acrylate copolymer A | 0.2 | 80 | 128 | Ethanol |
| Example 2 | Styrene-butyl acrylate copolymer A | 0.2 | 80 | 128 | Ethanol |
| Example 3 | Styrene-butyl acrylate copolymer A | 0.2 | 80 | 128 | Ethanol |
| Example 4 | Styrene-butyl acrylate copolymer A | 0.2 | 80 | 128 | Ethanol |
| Example 5 | Styrene-butyl acrylate copolymer B | 0.2 | 67 | 165 | Shell particle |
| | | | | | dispersed ethanol |
| Example 6 | Styrene-butyl acrylate copolymer C | 0.1 | 74 | 122 | Ethanol |
| Example 7 | Styrene-butyl acrylate copolymer D | 0.5 | 85 | 134 | Ethanol |
| Comparative | None | — | — | — | None |
| Example 1 | | | | | |
| Comparative | None | — | — | — | None |
| Example 2 | | | | | |
| Comparative | Styrene-butyl acrylate copolymer A | 0.2 | 80 | 128 | Ethanol |
| Example 3 | | | | | |
| Comparative | Styrene-butyl acrylate copolymer A | 0.2 | 80 | 128 | None |
| Example 4 | | | | | |
| Comparative | Styrene-methyl methacrylate copolymer E | 0.07 | 105 | — | Ethanol |
| Example 5 | | | | | |
| Comparative | Styrene-butyl acrylate copolymer F | 0.7 | 85 | 134 | Ethanol |
| Example 6 | | | | | |

The physical values of the toners of the Examples and the Comparative Examples are shown in Table 2.

TABLE 2

| | | | | | Toner | | |
|---|---|---|---|---|---|---|---|
| | Core particles | | Projections | | | | The number of particles |
| | Average particle | Coefficient of | Average particle | | Volume average | Coefficient of | of 3.0 μm or less in size |
| | size B (μm) | variation | size A (μm) | A/B | particle size (μm) | variation | (% by number) |
| Example 1 | 4.5 | 26 | 0.4 | 0.09 | 4.9 | 30 | 12.0 |
| Example 2 | 5.5 | 24 | 0.4 | 0.07 | 5.9 | 25 | 10.5 |
| Example 3 | 5.0 | 25 | 0.4 | 0.08 | 5.3 | 25 | 13.1 |
| Example 4 | 4.6 | 29 | 0.4 | 0.09 | 4.9 | 34 | 15.8 |
| Example 5 | 4.5 | 26 | 0.4 | 0.09 | 4.8 | 30 | 11.8 |
| Example 6 | 4.5 | 26 | 0.2 | 0.04 | 4.7 | 30 | 10.8 |
| Example 7 | 4.5 | 26 | 0.9 | 0.20 | 4.9 | 30 | 12.0 |
| Comparative | 4.6 | 29 | — | — | 5.5 | 24 | 7.0 |
| Example 1 | | | | | | | |
| Comparative | 5.9 | 37 | — | — | 5.9 | 41.8 | 30.0 |
| Example 2 | | | | | | | |
| Comparative | 5.9 | 42 | 0.4 | 0.07 | 5.9 | 42 | 30.0 |
| Example 3 | | | | | | | |
| Comparative | 4.5 | 26 | 0.2 | 0.04 | 5.0 | 29 | 10.2 |
| Example 4 | | | | | | | |
| Comparative | 4.5 | 26 | 0.1 | 0.02 | 4.6 | 31 | 11.8 |
| Example 5 | | | | | | | |
| Comparative | 4.5 | 26 | 1.0 | 0.22 | 5.2 | 35 | 27.1 |
| Example 6 | | | | | | | |

The toners of the Examples and the Comparative Examples produced as described above were evaluated.

### [Storability]

The respective toners was air-tightly put in an amount of 100 g into a polyethylene container. The container was allowed to stand still at 50° C. for 48 hours, and then the toner was taken out. The toner was sieved with a sieve of a #100 mesh. The weight of the toner remaining on the sieve was measured. The remaining amount, which was the ratio of this weight to the total weight of the toner, was obtained. The toner was evaluated on the basis of a criterion described below. As the numerical value thereof is lower, blocking of the toner is less easily caused so that the storability is better.

Good: Favorable. The remaining amount was less than 10%.

Poor: Poor. The remaining amount was 10% or more.

Into 100 parts of the respective toners of the Examples and the Comparative Examples obtained as described above was incorporated 1.0 part of silica particles subjected to hydrophobicity-imparting treatment with a silane coupling agent and having an average primary particle size of 20 nm. Furthermore, this external additive toner and a ferrite core carrier having a volume average particle size of 60 μm were mixed with each other to set the concentration of the external additive toner to 5% by weight. In this way, a two-component developer having a toner concentration of 5% was manufactured. The resultant two-component developer was used to form images for evaluation in a manner described below, and make evaluations described below.

[Durability of Developer]

The two-component developer was set into a commercially available copying machine (trade name: MX-2300G, manufactured by Sharp Corp.) having a two-component developing device. The machine was adjusted in such a manner that the toner was not developed on its receptor, and in this state only the developing device was continuously driven in a thermostat having a temperature of 35° C. for 5 hours. It was then checked whether or not aggregates were generated.

Good: Favorable. No aggregates were generated.

Poor: Poor. Aggregates were generated.

[Charge Amount]

The two-component developer was set into a commercially available copying machine (trade name; MX-2300G, manufactured by Sharp Corp.) having a two-component developing device. The machine was adjusted in such a manner that the toner was not developed on its receptor, and in this state only the developing device was continuously driven in a thermostat having a temperature of 35° C. for 3 minutes. Thereafter, the developer was sampled, and then a suction-type-charge-amount meter (trade name: 210H-2A Q/M METER, manufactured by Trek Co.) was used to measure the charge amount thereof. The charge amount was defined as the initial charge amount. Thereafter, the developing device was continuously driven for 5 hours and then the charge amount was measured. The charge amount was defined as the charge amount after 5 hours.

Good: Favorable. The absolute value of the change rate of the charge amount for 5 hours to the initial charge amount was less than 20%.

Poor: Poor. The absolute value of the change rate of the charge amount for 5 hours to the initial charge amount was 20% or more.

[Formation of Images for Evaluation]

The resultant two-component developer was charged into a developing device of a copying machine for tests, which was obtained by removing, from a commercially available copying machine (trade name: MX-2300G, manufactured by Sharp Corporation), a fixing device. A non-fixed solid image in the form of a rectangle having a length of 20 mm and a width of 50 mm was formed on a recording paper sheet of an A4 size prescribed in the Japanese Industrial Standard (JIS) P 0138 while the attachment amount of the toner was adjusted into 0.5 mg/cm². The feeding speed of the recording paper piece was set to 120 mm/sec, and an external fixing device was used to fix the formed non-fixed toner image. In this way, an image for evaluation was formed. The used external fixing device was a device obtained by remodeling an oilless type fixing device taken out from a commercially available full-color copying machine (trade name: LIBRE AR-C260, manufactured by Sharp Corp.) in such a manner that the surface temperature of its heating roll was able to be set into any value. At the time of evaluation, the surface temperature of the heating roller was set to 170° C. For reference, an oilless type fixing device is a fixing device for performing fixation without painting a release agent, such as silicone oil, onto its heating roller.

About the image formed when the surface temperature of the heating roller was 170° C., a reflective densitometer (trade name; RD918, manufactured by Macbeth Co.) was used to measure the optical reflection density of the solid image region. This density was defined as the image density. The image density was evaluated on the basis of the following criterion:

Good: Favorable. The image density was 1.40 or more.

Poor: Poor. The image density was less than 1.40.

[Fine Line Reproducibility (Character Disappearance)]

A character-image having a print ratio of 5% was printed, and then a character-breaking-off and a character-disappearance were observed with the naked eye.

Good: Favorable. The printed image was an image good in fine line reproducibility.

Poor: Poor. The printed image was an image poor in fine line reproducibility, wherein dropouts were present.

[Cleanability]

After the developer was used to print charts having a print ratio of 5% continuously onto 1,000 paper pieces. Thereafter, it was checked whether or not a filming was generated on the receptor surface with the naked eye. The cleanability of the developer was evaluated on the basis of the following criterion:

Good: Favorable. No filming was generated.

Poor: Poor. A filming was generated.

[Comprehensive Evaluation]

The results of the storability, the charging characteristics, the durability, the image density evaluation, and the cleanability were together considered, and comprehensively evaluated on the following criterion:

Good: Favorable. No evaluation results included “Poor”

Poor: Poor. One or more evaluation results included “Poor”.

Evaluation results of the Examples and the Comparative Examples are shown in Table 3.

TABLE 3

| | | | | Charge amount (−μC/g) | | | | | | | |
|---|---|---|---|---|---|---|---|---|---|---|---|
| | Storability | | | | 5 | | Image density | | | | |
| | Remaining | | | Initial | hours | | Measured | | Fine line | | Comprehensive |
| | amount (%) | Evaluation | Durability | time | later | Evaluation | value | Evaluation | reproducibility | Cleanability | evaluation |
| Example 1 | 6 | Good | Good | 18.0 | 18.8 | Good | 1.4 | Good | Good | Good | Good |
| Example 2 | 6 | Good | Good | 17.0 | 17.6 | Good | 1.4 | Good | Good | Good | Good |
| Example 3 | 5 | Good | Good | 17.4 | 18.6 | Good | 1.4 | Good | Good | Good | Good |
| Example 4 | 5 | Good | Good | 18.2 | 19.5 | Good | 1.4 | Good | Good | Good | Good |
| Example 5 | 5 | Good | Good | 17.0 | 18.8 | Good | 1.4 | Good | Good | Good | Good |
| Example 6 | 5 | Good | Good | 16.0 | 18.1 | Good | 1.4 | Good | Good | Good | Good |
| Example 7 | 5 | Good | Good | 15.0 | 17.8 | Good | 1.4 | Good | Good | Good | Good |
| Comparative | 15 | Poor | Poor | 18.0 | 11.0 | Poor | 1.4 | Good | Poor | Poor | Poor |
| Example 1 | | | | | | | | | | | |
| Comparative | 22 | Poor | Poor | 16.0 | 10.0 | Poor | 1.4 | Good | Poor | Poor | Poor |
| Example 2 | | | | | | | | | | | |
| Comparative | 22 | Poor | Poor | 14.8 | 9.0 | Poor | 1.3 | Poor | Poor | Poor | Poor |
| Example 3 | | | | | | | | | | | |
| Comparative | 5 | Good | Poor | 14.8 | 30.8 | Poor | 1.3 | Poor | Poor | Poor | Poor |
| Example 4 | | | | | | | | | | | |
| Comparative | 6 | Good | Good | 17.5 | 28.9 | Poor | 1.2 | Poor | Poor | Poor | Poor |
| Example 5 | | | | | | | | | | | |
| Comparative | 9 | Good | Good | 17.3 | 26.8 | Poor | 1.2 | Poor | Poor | Poor | Poor |
| Example 6 | | | | | | | | | | | |

The toners of Examples 1 to 7 were favorable in all of the evaluation items.

The toners of Comparative Examples 1 and 2 were poor in the evaluation items except the image density since the core particles were not coated with the shell particles.

The toner of Comparative Example 3 was poor in all of the evaluation items since the core particles were coated but the core average particle size was large so that the core particles were not sufficiently covered with the shell particles. Moreover, the specific surface area of the toner was low so that the charging characteristics of the toner and the image density were low. Additionally, the coefficient of variation was also large. It appears that the ratio of the toner particles having the number average particle size of 3.0 μm or less to the entirety of the toner particles increased and the image density was lowered by the increase.

The toner of Comparative Example 4 was poor in the evaluation items except the storability. Since no adhesion aiding agent was sprayed in the coating step, it appears that the shell particles were not sufficiently melt-bonded to the core particle surfaces.

The toner of Comparative Example 5 was poor in the items except the storability and the durability since the styrene-methacrylic copolymer was used in the shell particles. It appears that the strength of the cover layers was small.

The toner of Comparative Example 6 was poor in the items except the storability and the durability. Since the ratio of the toner particles having the number average particle size of 3.0 μm or less to the entirety of the toner particles according to the Coulter Counter was more than 25.0% by number, the toner melt-bonded to the developing blade, and a filming on the recording medium from the developing roller, the photoreceptor and others were generated. It appears that: the toner particles 3.0 μm or less in the number average particle size were not easily charged to a sufficient extent by the developing blade or the developing roller so that the charging stability lowered to cause toner scattering easily; the scattered toner particles easily caused image fog.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A toner comprising toner particles each composed of a core particle including a binder resin and a colorant and shell particles covering the core particle,
the toner particles having a volume average particle size of 4.0 μm or more and 8.0 μm or less,
the toner particles including toner particles having a number average particle size of 3.0 μm or less, at a ratio of 8% by number or more and less than 25% by number to an entirety of the toner particles, and
a part of each of the shell particles being melt-bonded to at least one of the core particle and another shell particle adjacent thereto whereby a projection is formed.

2. The toner of claim 1, wherein the volume average particle size of the toner particles is 4.0 μm or more and 6.0 μm or less, and toner particles having the number average particle size of 3.0 μm or less are contained at a ratio of 10% by number or more and less than 20% by number to the entirety of the toner particles.

3. The toner of claim 1, wherein 90% or more of the surface area of the core particle is covered with the shell particles.

4. The toner of claim 1, wherein a ratio of a projection average particle size, which is an average of projection particle sizes, which are each an average of long and short sizes of the respective projections, to a core average particle size, which is an average of core particle sizes, which are each an average of long and short sizes of the respective existing core particles, is 0.01 or more and 0.2 or less.

5. The toner of claim 1, wherein the shell particles contain at least one of a styrene-acrylic copolymer resin and a polyester resin.

6. A method of manufacturing the toner of claim 1, comprising a step of contacting the core particles with the shell particles in the presence of an adhesion aiding agent for increasing an adhesive strength between the respective core particles and the shell particles.

7. The method of claim 6, wherein the volume average particle size of the shell particles is 0.05 μm or more and 1 μm or less.

8. The method of claim 6, wherein the adhesion aiding agent contains at least one of water and a lower alcohol.

9. A two-component developer containing the toner of claim 1 and a carrier.

10. A developing device performing a development by using a developer containing the toner of claim 1.

11. An image forming apparatus having the developing device of claim 10.
